(19) United States
(12) Patent Application Publication
(10) Pub. No.: US 2012/0147169 A1
(43) Pub. Date: Jun. 14, 2012

(54) APPARATUS AND METHOD TO MONITOR CUSTOMER DEMOGRAPHICS IN A VENUE OR SIMILAR FACILITY

(75) Inventors: Joseph Cole Harper, Rollingwood, TX (US); Marc Scott Doering, Frisco, TX (US)

(73) Assignee: SCENETAP LLC, Rollingwood, TX (US)

(21) Appl. No.: 13/324,671

(22) Filed: Dec. 13, 2011

Related U.S. Application Data
(60) Provisional application No. 61/422,895, filed on Dec. 14, 2010.

(51) Int. Cl. H04N 7/18

(52) U.S. Cl. 348/77; 348/E07.085

(57) ABSTRACT

A venue monitoring and reporting system includes a network, a central server in data communication with the network, a customer device in data communication with the network, a local server in data communication with the network, the local server located at a venue remote from the central server, at least one camera in data communication with the local server, the at least one camera positioned to view a customer as the customer enters the venue, and wherein the central server, the customer device and the local server cooperate with the network to use images captured by the at least one camera to produce at least one of a total number of customers at the venue or a demographic characteristic of the customers at the venue, wherein the total number of the customers or the demographic characteristic of the customers at the venue is made viewable on the customer device.

### PRIORITY CLAIM

This application claims priority to and the benefit of U.S. Provisional Patent Application Ser. No. 61/422,895, filed Dec. 14, 2010, entitled “Method of Monitoring or Tracking Customer Demographics and Volume in a Venue or Similar Facility”, the entire contents of which are hereby incorporated by reference and relied upon.

### BACKGROUND

“Where are we going tonight? What is the crowd going to be like?” These questions are all too common among people getting ready to go out for an evening or to travel to a particular destination. These questions imply people's desire to be at the right place at the right time. The typical answer usually depends upon a combination of past experiences and researching as to where the ideal venues are for the evening. Everyone has a different definition of an ideal venue. For example, college-aged people may define an ideal venue as one with a lively single younger crowd, while older people may define an ideal venue as one with a more relaxed crowd. Even within these groups, people may be looking for more specific venue traits such as the gender mix, the types of clothing worn by people at the venue, similarities to people attending the venue, etc.

The problem is that most people do not exactly know which venues are ideal. Some people may rely solely on past experiences. However, a popular and trendy venue one day may soon become passé and deserted the next day. A venue's activity can even change hour to hour. As mobile Internet access has become widely available, some people attempt to identify an ideal venue by reading reviews and checking updates on social media sites. However, reviews only provide static information based upon a prior time a reviewer was at a venue. Additionally, social media sites may include overly subjective information making it difficult for someone to make an adequate assessment.

To resolve the above issues, people may compile a few known places and proceed to travel from venue to venue in an attempt to find an ideal or even adequate venue. However, this travel consumes time and resources, especially if the venues are geographically spaced apart. Many times, people may settle for a current venue out of convenience even though conditions are non-optimal. Alternatively, people may choose not to leave home due to the lack of information regarding venue activity.

There is accordingly a need for improved systems and methods for monitoring customer demographics and real-time information regarding social venues.

### SUMMARY

The present disclosure relates generally to monitoring, categorizing, and reporting customer demographics in a venue. More specifically, the present disclosure relates to using video, audio, motion detection devices, laser-based or radio frequency (“RF”) tracking devices, and/or any other devices to determine a traffic flow and demographics of customers in social venues, such as restaurants and nightclubs for example. The present disclosure also relates to using the customer demographic information to provide customer data and real-time information to at least three different user groups including: 1) customers, 2) venue operators, and 3) third parties. In this manner, the present disclose enables customers, venue operators, and third parties to gain knowledge about the happenings of venues across a city or other geographic location in real-time.

In the customer context, the example systems and methods provide real-time customer demographic information for one or more venue in a geographic location. For example, the systems and associated methods compile real-time customer demographic information from multiple venues, analyze the information for each venue, and display on (i) a website and/or (ii) a mobile application, demographic information for each venue. The demographic information may include a total number of people currently at a venue, a percentage of capacity filled for a venue, a ratio of males to females, an average age of males and females, a ratio of hair colors of customers, an approximate income level of customers, approximate percentages of race and/or ethnicity at a venue, approximate averages of height/weight, a percentage of people with glasses and/or facial hair, general descriptions of clothing type (e.g., jeans, skirts, sport coats, dresses), and/or general indicators of attractiveness. Additionally, the example systems and associated methods may determine descriptions of a scene or mood of a venue (e.g., relaxed, dead, hopping, crazy, loud, intense, dance, energized etc.) based on the analyzed demographic information.

In a venue operator context, the example methods and systems compile customer demographic information into history trends and/or provide real-time updates to a venue operator based on analyzed demographic information. For example, history trends may inform venue operators which types of people appeared at their venues at specific times of a day and/or days of a week. This may help venue operators identify target markets for advertising. Additionally, real-time demographic information may be used by venue operators to select appropriate music and/or ensure there is enough food and drink and types thereof for the customers. Further, the example systems and methods may enable venue operators to manage their venue's information on a customer oriented website and/or mobile application. For example, a venue operator may decide to otter an evening special to attract more people to the venue. Still further, the example systems and methods enable the venue operators to monitor competitor venues.

In a third party, e.g., vendor, context, the example systems and methods may be used to promote marketing information and create marketing reports. The marketing reports may be sold to advertisers and/or any other interested party who wants to know customer demographics and associated product usages of different venues in a particular area. For example, billboard companies may use venue demographic information to select advertisements in proximity to certain venues that are targeted towards the demographics of customers who frequent the venues. In other instances, real estate developers and/or business planners may use demographic information to identify locations for new venues that cater to certain demographics.

Product usage information can be sold to food and drink manufacturers and distributors. Advertisers may also use any of the demographic and/or product usage data discussed herein.

To illustrate the systems and methods disclosed herein, reference is made to restaurants and bars. However, the example systems and methods can be applied to any venue location that caters to customers (e.g., restaurants, bowling allies, movie theaters, clubs, parks, retail stores, malls, grocery stores, cafés, gas stations, stadiums, schools, museums, etc.). Any of these locations can include or use a system according to the present disclosure, which may include a detection subsystem (e.g., facial or demographic detection and recognition), a traffic flow subsystem, and a local server communicatively coupled to a centrally located monitoring server (described in detail herein). In other examples, functionality of a local server and/or a monitoring server (described in detail herein) may be combined and located at a central location or, alternatively, may be implemented in a cloud computing environment.

The detection subsystem includes a camera and affiliated software programs to identify demographic information of customers entering a venue. The detection subsystem may be positioned such that all customers entering a venue pass through a visual target region of the system. The processing software uses facial detection and/or recognition algorithms to determine, for example, an age, a gender, a race, a height, and/or a weight of a customer. In some examples, the processing software may also identify facial hair, glasses, hair color, clothing type and/or any other information discernable from a customer. In other examples, the detection subsystem may include microphones and/or RE sensors to detect words spoken by a customer and/or mobile device information authorized to be transmitted by a customer.

The example traffic flow subsystem includes a proximity detecting sensor and/or camera to determine a number of people who enter and leave a venue. In some examples, more than one traffic flow subsystem may be used in a venue to determine an amount of customers in different areas of a larger venue for example.

The example local server compiles video, digital and/or analog data from the traffic flow subsystem and the demographic detection and/or recognition subsystem. The local server uses a combination of empirical data, software, and algorithms described herein to determine demographics of customers based on recorded video images of the customers (e.g., demographic detection). The local server may also identify customers by matching video images of customers to databases with images of the customers (e.g., demographic recognition).

The local server then prepares and transmits the demographic information to a central monitoring server. The local server may transmit the information at predetermined time periods (e.g., every minute, every five minutes, every fifteen minutes, etc.). In other instances, the central server may request the information from the local server. In some examples, the local server may be implemented by a computer, a processor and/or any other device. In yet other instances, the local server may be bypassed entirely.

In the illustrated example, the central server receives demographic information from separately positioned local servers at different venues in a hub-and-spoke type of arrangement. The central server analyzes the information for each venue to determine demographic statistical information and stores this information. The central server then updates demographic information displayed to customers via a webpage and/or mobile applications. The central server may further send messages to customers who request to be notified based on certain demographic conditions at specific venues (e.g., send a text message to a customer when there are more than 60% women under thirty years of age at venue ABC). The example central server may also recommend venues to customers based on search criteria provided by a customer (e.g., venues within one mile of zip code 60602 having a current ‘lively’ status).

The central server of the systems and methods herein can also use the analyzed demographic information to create venue specific demographic history reports for venue operators and/or demographic reports for third parties. In some examples, venue operators and/or third parties may access, filter, and/or analyze the stored demographic information through custom reports that access data on the central server. Additionally or alternatively, venue operators and/or third parties may subscribe to periodic reports generated by the central server.

The example central server may further determine if venue operators have set specific triggers, which display a deal, a coupon, and/or advertisement on a webpage and/or transmit messages to a consumer based on the real-time determined demographic information. Some examples here can include the setting by the venue operators of operational triggers such as sending a venue disk jockey (“DJ”) a message to change the music type and/or sending a message to a bartender or restaurant to prepare particular types of beverages or food item or to have a particular beverage or food item on hand. Additionally, the central server may include a website interface that enables venue operators to view real-time demographic information and make changes (e.g., display an advertisement, display a message, offer a daily deal, etc.) to venue information on a webpage and/or mobile application.

It is accordingly an advantage of the present disclosure to provide improved systems and methods for monitoring customer demographics in venues.

It is another advantage of the present disclosure to display real-time customer demographic information for venues via a webpage or a mobile application.

It is a further advantage of the present disclosure to analyze real-time customer demographic information for venues and provide demographic reports to venue operators and/or third parties.

It is yet another advantage of the present disclosure to analyze real-time customer demographic information from venues and determine if notification and/or alerts should be transmitted to venue operators, third parties, and/or customers.

Additional features and advantages of the system and methods are described herein and will be apparent from the following Detailed Description and figures.

### BRIEF DESCRIPTION OF THE FIGURES

FIG. 1 illustrates an example venue monitoring environment and system of the present disclosure, including venues, potential customers, venue operators, third parties, and a system manager.

FIGS. 2 and 3 are flowcharts according to an embodiment of the present disclosure representative of machine-accessible instructions, which may be executed to implement the system manager of FIG. 1.

FIG. 4 illustrates a schematic of relationships between the customers, venues, venue operators, and third parties described in conjunction with FIG. 1.

FIGS. 5A and 5B illustrate an example detection subsystem in a venue.

FIG. 6 illustrates demographic detection of the example detection subsystem of FIG. 5A.

FIGS. 7 to 9 illustrate example detection subsystems in use in a venue.

FIGS. 10 and 11 illustrate example schematics of a local server communicatively coupled to a detection subsystem and a central server of FIG. 1.

FIGS. 12 to 14 show example venue operator registration interfaces.

FIGS. 15 to 18 illustrate example customer context applications displaying real-time venue information and customer demographic information.

FIG. 19 is a flowchart according to an embodiment of the present disclosure which is representative of machine-accessible instructions that may be executed to collect real-time venue information and customer demographic data.

FIGS. 20 and 21 illustrate third party context applications having demographic histories for one or more of venues.

FIG. 22 is a schematic illustration of an example processor platform according to an embodiment of the present disclosure, which may be used and/or programmed to execute the example processes and/or the example machine-accessible instructions of FIGS. 2, 3, and 19 to implement any or all of the example methods, apparatus and/or articles of manufacture described herein.

### DETAILED DESCRIPTION OF THE DRAWINGS

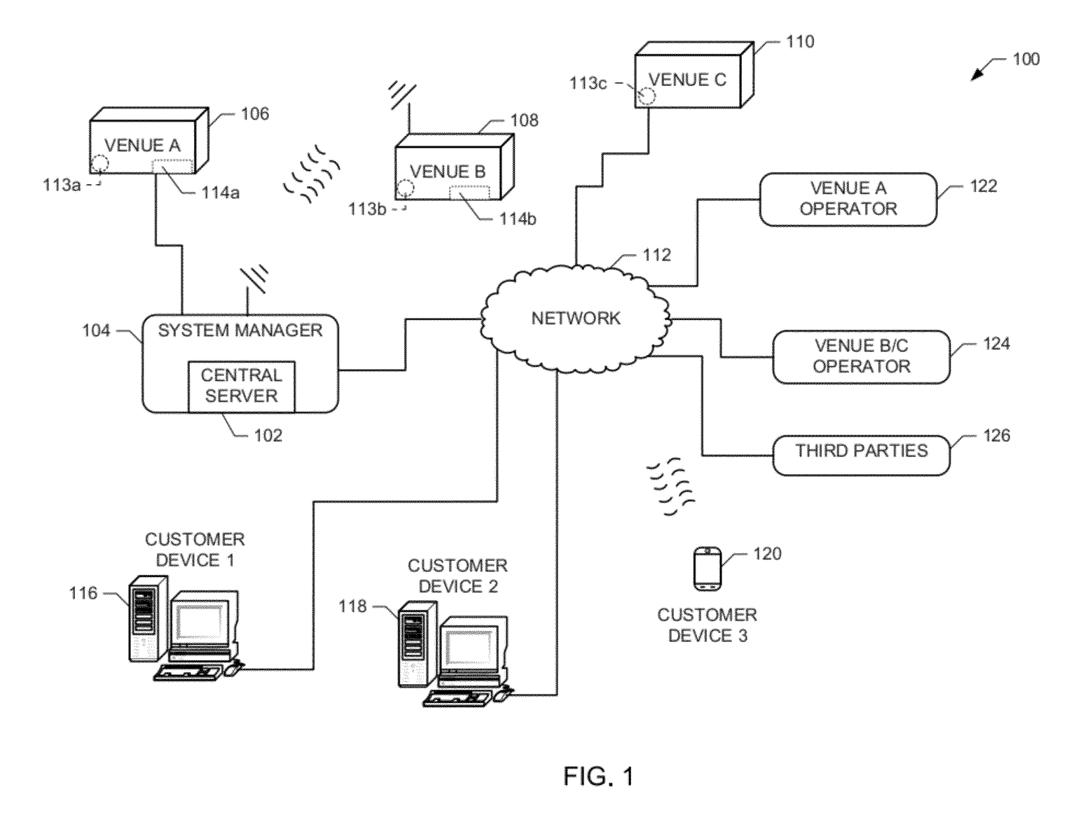

In the interest of brevity and clarity, throughout the following disclosure, reference will be made to an example venue monitoring system 100 of FIG. 1, which uses a central server 102 located at a system manager 104 to determine customer demographics and real-time information of venues 106, 108, and 110 (e.g., nightclubs or bars). However, the systems, methods and articles of manufacture described herein are applicable to other types of venues including, for example, restaurants, bowling allies, movie theaters, clubs, parks, retail stores, malls, grocery stores, cafés, gas stations, stadiums, schools, and museums. Additionally, the systems, methods and articles of manufacture described herein are applicable to other types of monitoring environments, including, for example, manufacturing environments, process control environments, and medical environments.

### Venue Monitoring Environment

FIG. 1 shows the venue monitoring system 100 including venues 106 to 110. The system 100 can represent a geographical area such as a neighborhood, a town, a city, a region, a state, etc. Venues 106 to 110 represent commercial establishments that customers visit to receive goods and/or services. While the three venues 106 to 110 are shown, system 100 can include additional or fewer venues.

In the illustrated example, the venues 106 to 110 are communicatively coupled to a system manager 104. Venue 106 is communicatively coupled to the system manager 104 via a direct wired connection (e.g., a Local Area Network (“LAN”) hosted by the central server 102, venue 108 is wireless communicatively to the system manager 104 via a wireless connection (e.g., a wireless LAN “WLAN”), while venue 110 is communicatively coupled to the system manager 104 via a network 112 (e.g., an Internet Protocol-based switching network). Venues 106 to 110 thereby illustrate multiple ways of being connected to system manager 104. System 100 is further alternatively completely wired, completely wireless, completely local and/or completely wide area. The network 112 may therefore be any one or more of a local area, a wide area and the Internet.

The example venues 106 to 110 each include a respective detection subsystem 113a, 113b, and 113c, which have cameras, sensors and other equipment discussed in detail below for detecting and recording real-time venue and customer demographic information. The subsystems can use multiple cameras described in detail below. Additionally, detection subsystems 113a to 113c can include one or more proximity sensor to detect customers entering and leaving a venue, which operate with the one or more camera to selectively record video of customers entering and leaving a venue. The proximity sensor can be one or more photo-electric sensors in which a beam of light is interrupted by an entering customer. The detection subsystems 113a to 113c can also include other types of sensing equipment including, for example, one or more microphone to detect decibel levels or types of music being played, thermometers, light intensity sensors, etc.

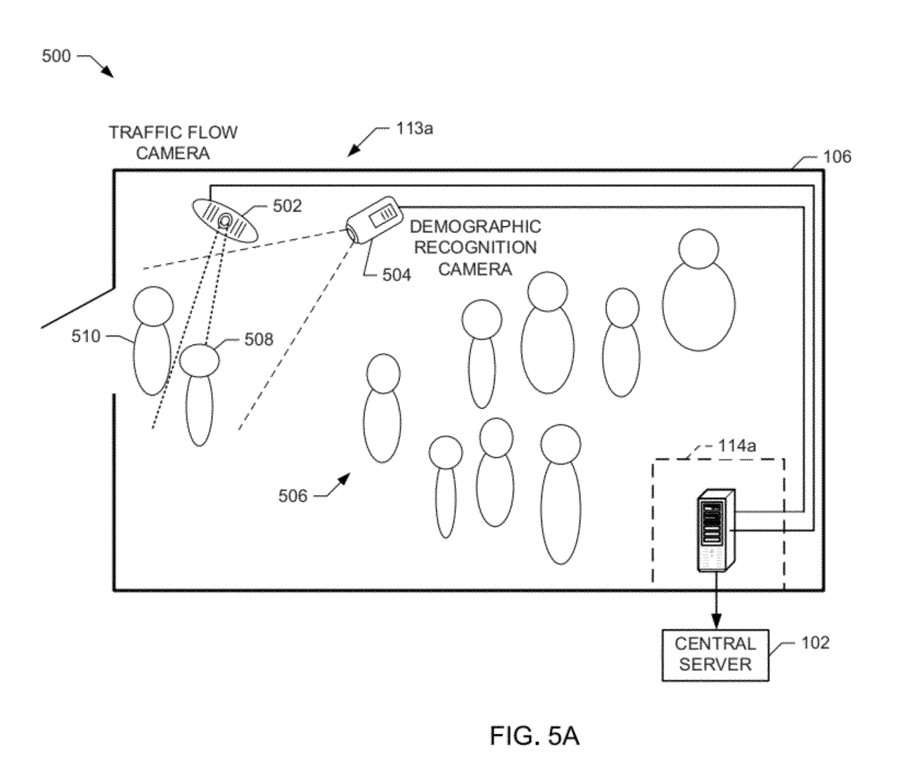

Detection subsystems 113a to 113c for different venues can include similar components or be tailored for a specific venue. For example, the detection subsystem 113a may include two traffic flow sensors and a demographic camera, while the detection subsystem 113b may include four traffic flow sensors and three demographic cameras. In many instances, the number and/or types of sensors in each detection subsystem is dependent upon a layout, size, shape, number of entrances/exits, number of floors, number of rooms and/or furnishings in a venue. Additionally, different venue operators may desire different levels or types of detection, requiring different numbers and/or types of sensors to be used in their venues. The detection subsystems 113a to 113c are described in further detail in conjunction with FIGS. 5 to 11.

Example venues 106 and 108 also include respective local servers 114a and 114b to receive detected and recorded data from the detection subsystems 113a and 113b. In the illustrated example, venue 110 does not include a local server. Instead for venue 110, detection system 113c transmits real-time information and demographic data directly to the central server 102 via network 112. In this instance, for venue 110, the central server 102 also performs functions that the local servers 114a and 114b perform for venues 106 and 108, regarding, for example, data received from venue 110.

Example local servers 114a and 114b of FIG. 1 include hardware and/or software (e.g., StatCollector™ software) that is programmed and manipulated to integrate, compile and process data received from the detection subsystems 113a and 113b. The processing and integration includes the performance of demographic detection and/or recognition of the video taken of customers entering a venue and updating a count of customers and other measurables for the customers in the venue. For instance, updating a traffic flow of customers can include periodically instructing traffic flow cameras to obtain a count of a number of people in a venue. The local servers 114a and 114b can also maintain records for a number of customers entering and leaving, a number of customers relative to venue capacity and/or a number of customers relative to venue size.

Additionally, facial recognition algorithms implemented by the local servers 114a and 114b analyze video of customers to determine physical characteristics (e.g., age, gender, height, weight, etc.). After determining at least some of these physical characteristics for a number of customers, the local servers 114a and 114b create a record summarizing the information. The local servers 114a and 114b then transmit the records to system manager 104 via network 112 for analysis and display. Venues 106 and 108 may transmit the reports periodically, as the reports become available, or upon request from the system manager 104.

In some instances, the local servers 114a and 114b use the facial recognition algorithms to match a customer to an identity. For example, the identity can be created by the customer specifically for the venue monitoring system 100, receive special discounts or frequent venue points. In these instances, the local servers 114a and 114b may access identity information from the central server 102. In other instances, the local servers 114a and 114b access third party servers that store customer information (e.g., a social network, such as, Facebook™) for identity information. In these instances, the local servers 114a and 114b can locate attributes or profile information (e.g., name, birth date, hobbies, etc.) that are associated with a customer. The example local servers 114a and 114b then update the record at central server 102 the identity of customers with the corresponding attributes. For example, a stored attribute may be males that are six feet or taller. When a customer fitting this description walks into the venue, system 100 captures the customer's image, notes that the customer is likely six feet or taller and then looks for his facial image on system 100 itself (already stored) or on a third party server, e.g., a social network. If this person's identity is found, a new file can be created for the person and/or the attribute, e.g., six feet or taller, along with other stored attributes learned about from the third party server can be updated.

The example central server 102 of FIG. 1 analyzes the demographic data and real-time information received in the reports from the venues 106 and 108. Additionally, the central server 102 analyzes demographic data and real-time information from venue 110 based on its own stored demographic recognition and/or detection algorithms. Central server 102 routes the reports into appropriate databases corresponding to the venues 106 to 110. For example, a report received from the venue 106 is routed to a database designated for venue 106. Additionally, a general database for an attribute, e.g., six feet or taller, can be kept for multiple ones on all of the venues of system 100.

For each of the venues 106 to 110, the central server 102 uses region-specific rules and/or algorithms to determine a demographic profile for the venue based on the newly received data combined with previously received data and/or historical data. For example, customer count information may include a total number of customers who entered venue 106 in the previous live minutes. In this example, the central server 102 adds this change in customers to the previous stored total number of customers.

After central server 102 has updated the demographic data and real-time information for venues 106 to 110, central server 102 makes the information available for display via a website or a mobile application. For example, any of customer devices 116, 118, and 120 can access the posted information in the central server 102 via the network 112. In this manner, potential customers can view real-time demographic and venue information for each of the venues 106 to 110 before determining which venue they will visit.

The customer devices 116 to 120 are shown as including computers and smartphones. The customer devices 116 to 120 can also include tablets, laptops, or any other type of computing device having data sending and receiving capability, e.g., via cable, satellite, cellular connection and any combination or deviation thereof. Further, while only three devices 116 to 120 are illustrated for ease of illustration, the venue monitoring system 100 can include many additional devices accessing the central server 102, including devices accessing the system 100 locally, nationally and multi-nationally.

Central server 102 also makes the information available to the venue operator interfaces. FIG. 1 shows a venue operator 122 (for venue A) and a venue operator 124 (for venues B and C), which can access real-time and historical demographic and real-time information stored in the central server 102. In the illustrated example, venue operator 122 accesses the central server 102 regarding information for the venue 106, while venue operator 124 accesses the central server regarding information for the venues 108 and 110. The venue operators 122 and 124 access the data on the central server 102 via the network 112 using secure or un-secure interfaces.

The example venue operators 122 and 124 may use the demographic and real-time information to manage the operations of the venues 106 to 110. For example, venue operator 122 may determine from the information that there are few customers currently within the venue 106 and decide to offer a nightly special to attract more people. Additionally, venue operator 122 may use historical data to plan geographic-specific and demographic-specific target marketing materials and events. For example, the data may show that certain holidays tend to bring more females to the venue, which the operator can use to offer certain specials or entrees.

In some examples, venue operators 122 and 124 can specify notification or alert conditions based on demographic data or real-time information. When a condition is satisfied, central server 102 sends a notification to the appropriate venue operator 122 or 124. For example, the venue operator 124 may set a condition to send a notification to the venue operator (e.g., an e-mail or short message service “SMS” communication) when an average age of customers in the venue 108 exceeds forty-five percent so that appropriate music is played or when a percent of capacity falls below 25 percent, so that excessive staff can be sent home or so that drink or food specials can be offered at the venue and/or to be posted for availability on customer services devices 116, 118 and 120.

Additionally, in some examples the venue operators 122 and 124 may request or accept recommendations from the system manager 104 based upon historical and/or real-time data regarding venues 106 to 110. Here, the central server 102 can use a forecasting system that analyzes the historical and/or real-time data for a venue to determine how a venue operator can, for example, increase a number of customers or change a type of average demographic of customers. In a specific example, the central server 102 determines the customer traffic for the venue 108 is low on Tuesdays with an average male-to-female ration of 2:1. In this example, central server 102 may recommend to run more ladies-night specials on Tuesdays to gain an estimated twenty to thirty customers, for which the ratio of females to males increases.

Still further, central server 102 of FIG. 1 can make data selectively available to third parties 126. For example, central server 102 can provide historical data for one or more venue in a marketing report purchased by the third party 126. The third party 126 may be interested in particular customer demographics for certain type of venues or for venues in a particular area. The third party 126 may use this information for the advertising of products or services targeted to customers like the customers of venues 106 to 110. In other instances, real-estate developers may be interested in particular customer demographics for a particular area for building planning purposes. In still another example, a potential venue owner (such as for a new restaurant) may wish to have demographic information for a particular city, area of a larger city, or suburb.

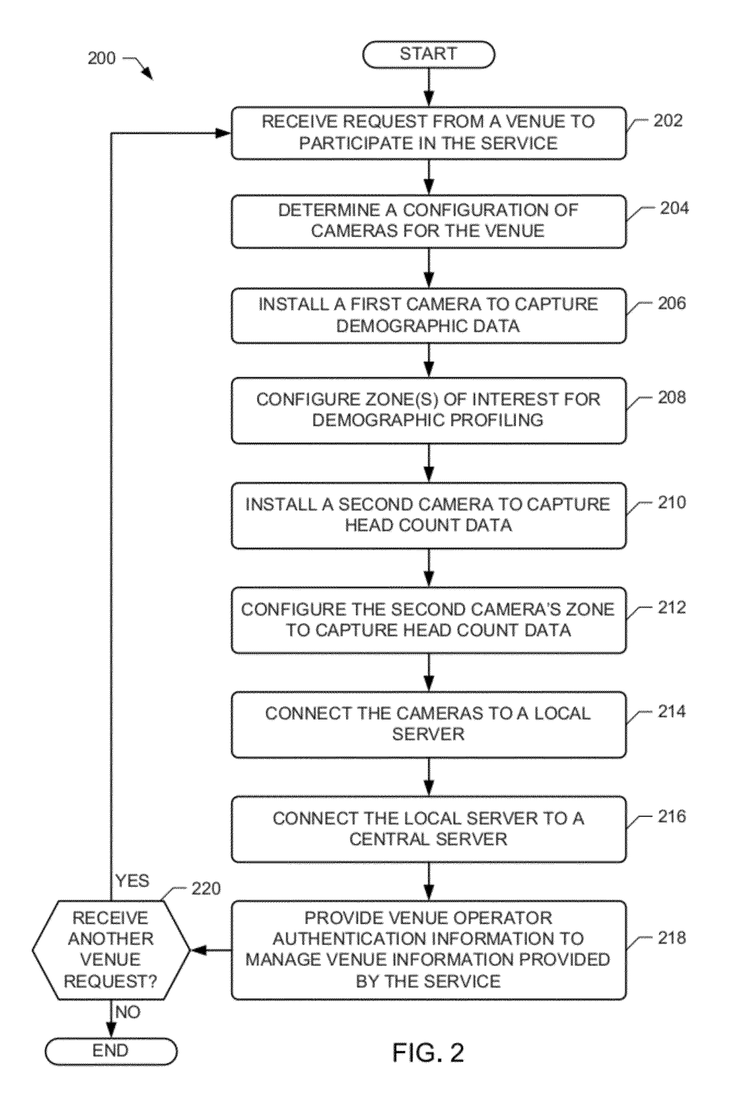

FIG. 2 illustrates a flowchart of an example process 200 for adding a venue to the venue monitoring system 100 of FIG. 1. After beginning at “START,” the process 200, e.g., at system manager 104, receives a request from, for a venue operator like venue operator 122 to participate in the venue monitoring system 100 (block 202). Personnel associated with the system manager 104 then receive information regarding the target venue (e.g., venue 106 of FIG. 1), receive preferences from the new venue operator, and determine a suggested configuration of sensors and cameras for the venue (block 204). In this example, the system manager 104 determines that the new venue is to have a traffic flow camera/sensor and a demographic recognition camera (e.g., the detection subsystem 113a described in more detail below in connection with FIG. 5A). If the new venue had been configured differently, a different camera and sensor arrangement might be recommended, in which additional cameras and/or different types of cameras/sensors are suggested.

The personnel of the system manager 104 then install the demographic recognition camera and configure zones of interest within a field of view of the camera (blocks 206 and 208). The zone of interest may correspond to a location inside of a main doorway that is free of visual obstructions. The camera is installed to capture video of customers at an angle so that a facial recognition algorithm provided for example with the StatCollector™ software can determine physical attributes associated with the customers. The system manager personnel next install a traffic flow camera and configure a detection zone (blocks 210 and 212). It should be appreciated that the order of the installation of the cameras can be reversed. The detection zone corresponds to a location at the focus area of the first camera, e.g., at the entryway of the venue. In another example, the venue may have traffic flow cameras and/or sensors located throughout the venue to accurately count and analyze the customers in different areas of the venue.

After installing the detection subsystem, e.g., 113a, the personnel communicatively couple the subsystem 113a to a local server, e.g., server 114a, via any wired or wireless communications medium (block 214). The personnel next configure the local server 114a to process and compile data from the detection subsystem 113a and communicatively couple the local server 114a to the central server 102 (block 216). The personnel may configure the local server 114a to connect to the central server 102 by specifying an IP address and security protocol(s) of a node of the server 102 that the server 114a is to securely access to receive and transmit compiled reports from and to the venue, e.g., venue 106.

The system manager 104 then provides the associated venue operator, e.g., venue operator 122, with authentication information, which enables the operator 122 to access real-time and historical data for the venue 106 that has been processed by the central server 102 (block 218). The authentication information may also be needed to enable the venue operator 122 to interface with customer-facing webpages and/or applications to update information, advertisements, specials, etc., for the venue 106. Further, the authentication information may also enable the central server 102 to transmit notifications to the venue operator 122. At block 220, process 200 determines if another venue is to be added. If so, process 200 returns to block 202 and repeats blocks 202 and 218 for another venue. If not, process 200 ends as illustrated.

While the example process 200 has been described as being carried out by personnel of the system manager 104, in other examples, the venue operator 122 may alternatively install, configure, and connect the cameras and sensors. Here, system manager 104 (or a third party provider) may provide the cameras, sensor software and connectivity equipment. Further alternatively, the venue operator 122 may acquire, install and connect the cameras and sensors. In these examples, the venue operator 122 may register with the system manager 104 to incorporate the venue 106 into the venue monitoring system 100 by configuring the local server 114a with software for compiling, analyzing, and sending reports of real-time information and customer demographic data to the central server 102.

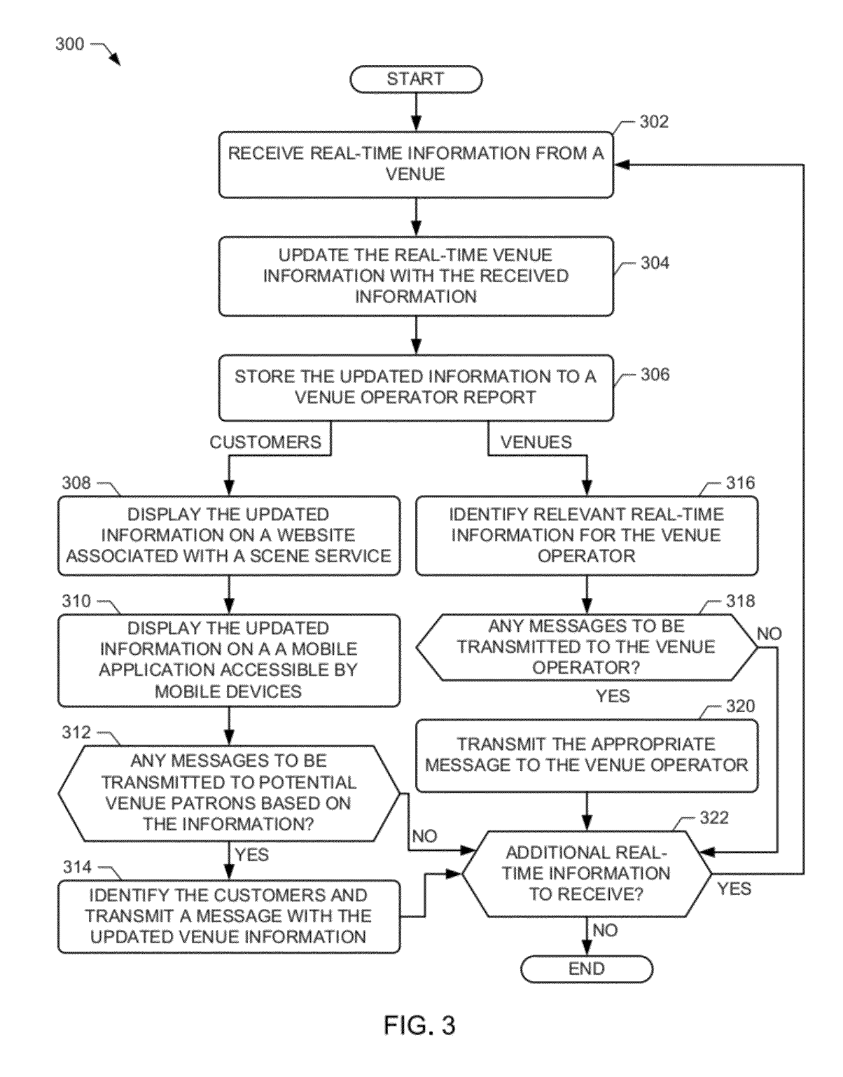

FIG. 3 shows a flowchart of an embodiment of a process 300 executed by central server 102 to analyze, manage, and display real-time data received from a venue, e.g., venue 106. While process 300 is shown for convenience as being executed sequentially by central server 102, in other examples server 102 can rearrange and/or execute the blocks in of the process 300 as needed (e.g., in parallel, concurrently, etc.). Additionally, multiple versions of the process 300 may be executed by central server 102 in parallel for different venues, e.g., each of the different venues 106 to 110. That is, venues 106 to 110 can each run their own customized version of process 300 simultaneously on server 102

Process 300 begins at START, after which central server 102 receives a report with real-time venue and customer demographic information from a venue, e.g., the venue 106 (block 302). Central server 102 then locates the appropriate database and updates the stored information with the newly received information (block 304). Central server 102 also stores the updated information to a venue operator report, which displays historical venue information (block 306). Venue information can also update a customer identification database, e.g., add a file for a newly recognized customer or update an attribute category, e.g., male, six feet or taller with a customer name.

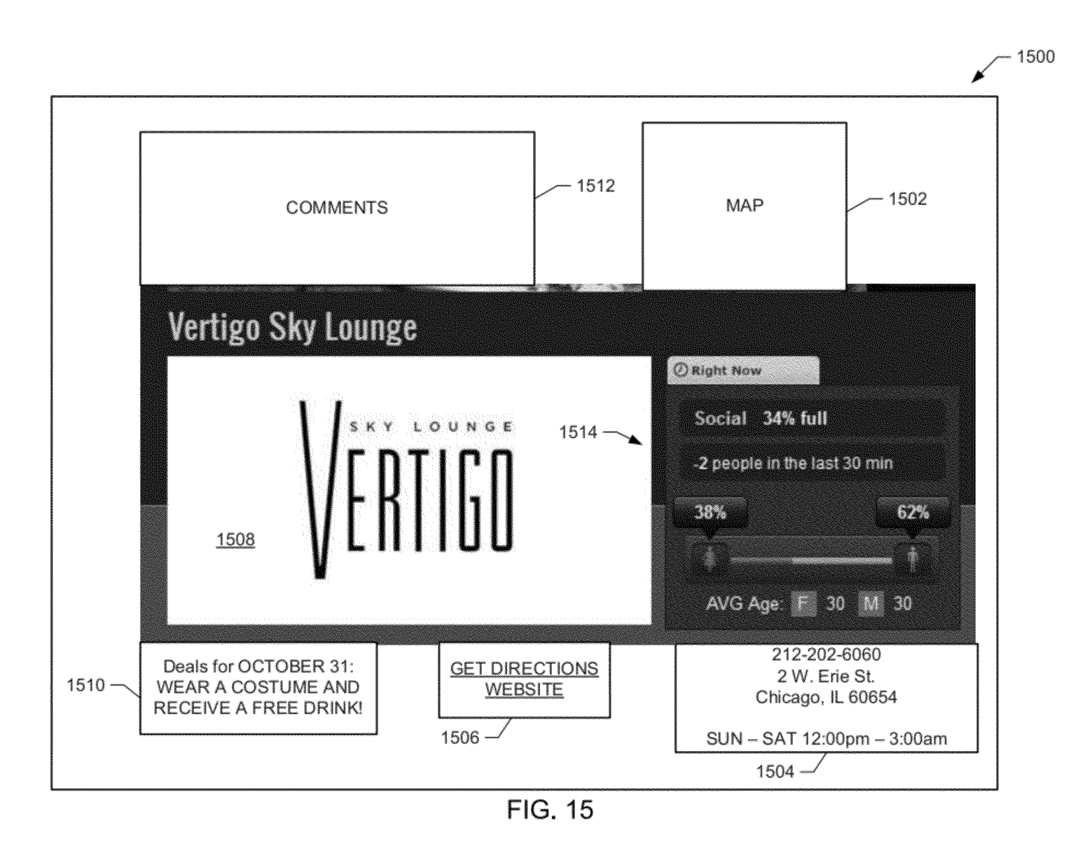

The example central server 102 then performs a series of steps for use in a customer context and a series of steps for use in a venue operator context. In the customer context, central server 102 updates customer-accessible web servers and externally facing databases within the most recent real-time venue and customer demographic information (Hock 308). For example, central server 102 updates a hosted website that enables potential customers to view customer demographics for the particular venue 106. In another example, central server 102 can transmit the updated information to customer-orientated applications and applets (block 312). These applications and applets operate on smartphones or other mobile devices belonging to the customers, for example. An example application or applet is shown below in FIGS. 15 to 18. The application or applet can give the same or similar demographic information as the website.

The example central sever 102 next determines if any customers have subscribed to, e.g., requested information about, the venue 106 by specifying one or more conditions to trigger a notification (question block 312). For example, a customer may request to receive a notification when the female-to-male ratio of venue 106 exceeds 2:1, when an average customer age of the venue is between twenty-five and twenty-nine, or when a music type of the venue 106 changes to 80s classic rock. If one or more notifications are to be transmitted, central server 102 identifies the customers to receive the notifications, determines the information to be included in the notifications, and transmits the notifications to the appropriate customers (block 314).

After transmitting the notifications (block 314), or if no messages are to be transmitted to potential customers (question block 312), the central server 102 determines if additional real-time information has been received from the venue 106 (question block 322). If so, the central server 102 returns to receiving reports from the venue 106 (block 302). If not or the central server 102 is taken offline (such as for maintenance), the process 300 ends as illustrated in FIG. 3.

Regarding the venue operator context, the example central server 102 identifies relevant real-time information for the venue operator e.g., the operator 122 (block 316). The venue operator 122 may previously specify which information the central server 102 is to consider as relevant. Central server 102 then determines if any notifications (e.g., e-mail messages, text messages, automated voice messages, etc.) should be transmitted to the venue operator 122 based on the updated real-time venue and customer demographic information (block 318). If a notification is to be transmitted, the central server 102 determines the information to include in the notification and transmits the notification to the venue operator 122 (block 320). For example, the venue operator can receive a message when total patrons or a demographic, e.g., male versus female, reaches a certain number or percentage. The process 300 also contemplates enabling the operator 122 of the venue 106 to view certain information, e.g., total numbers or demographics for another venue 106 or 110. The venue operator 122, for example a sports bar owner, may be particularly interested in the current numbers and demographics at similar, rival sports bar.

After determining if any messages should be transmitted to the venue operator 122, the central server 102 determines if there are additional reports to receive (question block 322). If there are additional reports, the central server 102 returns to receiving reports from the venue 106 (block 302). Otherwise, the process 300 ends as illustrated in FIG. 3.

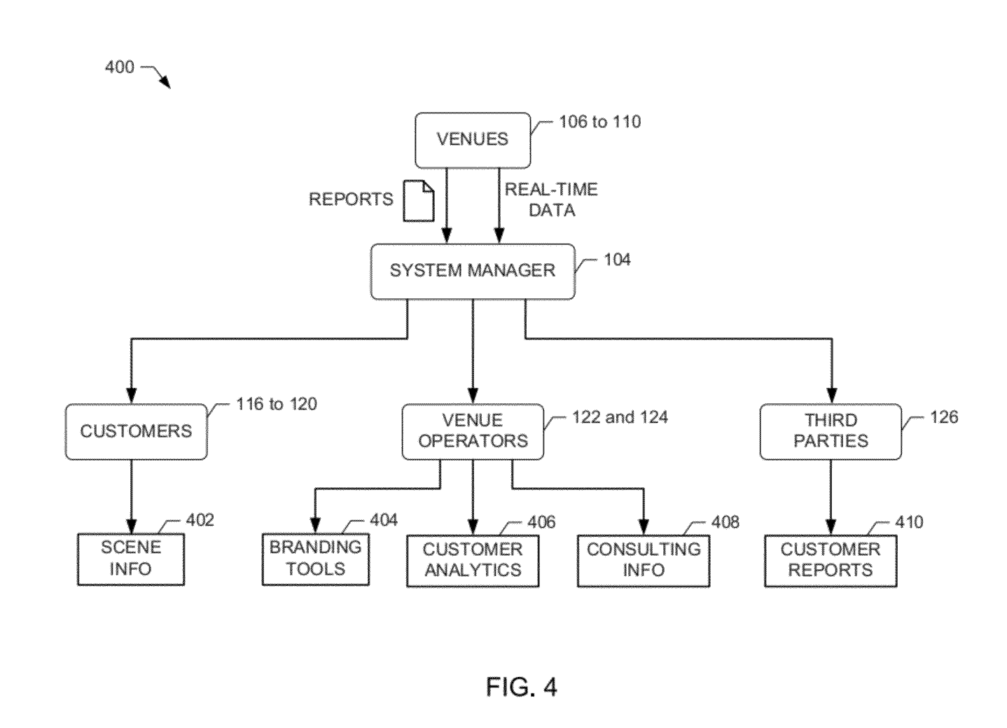

FIG. 4 illustrates a schematic 400 of relationships between the customers, venues, venue operators, and third parties described in conjunction with FIG. 1. In the example function tree, venues 106 to 110 generate reports of real-time venue information and customer demographic data including, counts, physical characteristics and identified attributes of customers. The information can be transmitted in a report, as raw data, or in both formats.

The physical characteristics can include, for example, age (or age range), height, weight, gender, ethnicity, race, facial hair, hair color, hair length, hair style, eye color, jewelry worn, clothing style, type, or brand, facial expressions, body language, attractiveness, body tone, skin tone, bone structure, body composition, look-a-likeness to famous people, piercings, tattoos, etc. Many of the above-listed physical characteristics can be communicated as ranges. Others are yes/no types of characteristics, such as facial hair, for which a percentage of customers are communicated. Here, the percentage can be hedged with a percentage accuracy or be presented in a format that provides some leeway, e.g., likely more than X % of men with facial hair. Examples of specific algorithms for determining certain physical characteristics of the customers are discussed next.

### Customer Height Algorithm

The central server 102, the camera 504 and/or the local server 114a determines a height of customers in one embodiment by analyzing video of customers entering a venue. The height can be determined by comparing a height of the customer against a known height on a wall, door, or other fixed features of the venue (e.g., markers) and determining a distance between the customer and the one or more markers. Height can be displayed as an average male height and average female height in the venue 106 as detected by demographic recognition camera 504 and analyzed by the camera 504, the local server 114a, or the central server 102. The local server 114a then assigns this height to the customer and stores the information as a physical characteristic.

### Customer Weight/Body Type Algorithms

The central server 102 or the local server 114a determines a weight or a body type of customers by comparing video of customers entering a venue to baseline images of generic body types. The central server 102 or the local server 114a identifies a body outline of the customer and compares this to different body shapes based upon height, width, and shape. The central server 102 or the local server 114a selects the body shape that best matches the body outline of the customers and assigns these physical characteristics to the customer.

Customer weight can also be determined using the camera 504 and one or both of the servers 114a and 102. The camera 504 detects a total height and one or more width dimensions of the customer. The height and width dimensions (width can be averaged if multiple readings are taken for a customer or a largest reading can be used) are multiplied to produce a customer body area. An average customer depth can be assumed or measured via the camera 504. The weight is based upon customer volume. Alternatively, depth can be eliminated and weight can be judged based upon customer area. Still further, weight can be judged based on upon customer height and sex. The width of a customer can be averaged in one embodiment to provide an overall width grade (e.g., slender, mid-size, large, etc.) that is processed by the local server 114a.

### Customer Attractiveness

The central server 102 or the local server 114a determines attractiveness by analyzing video images of a customer. The local server 114a may use software that applies an array of measurements on geometry and symmetry to a face of the customer. The local server 114a measures proportions between eyes, nose, ears, and lips and references these proportions to a corresponding level of attractiveness (such as beautiful, handsome, homely, etc.). The attractiveness levels are averaged and an overall or cumulative attractiveness grade is determined and displayed for the venue 106. The local server 114a could use software from, for example, the University of Nebraska as described in the article: http://news.softpedia.com/news/New-Software-Tells-You-How-Attractive-is-Your-Face-for-the-Opposite-Sex-80656.shtml.

Alternatively or additionally, the software attempts to match video of a customer's face to stored facial images in a database. The stored facial images are assigned attractiveness levels. The local server 114a assigns a customer an attractiveness grade that corresponds to the grade of the closest match that can be made with one of the known attractiveness images.

### Customer Ethnicity

The central server 102 or the local server 114a determines an ethnicity by analyzing video images of the customer. The local server 114a uses software that applies an array of measurements on geometry and symmetry to a face of the customer. The local server 114a measures proportions between eyes, nose, ears, and lips and references these proportions to a corresponding ethnicity. The local server 114a sums different ethnicities in the venue 106 and determines an overall percentage of each ethnicity in the venue 106. The central server 102 uses this information to display percentages of each ethnicity of customers at the venue 106. The local server 114a could use, for example, Face Room of Poser software to determine ethnicity.

### Mood of a Venue

The central server 102 or the local server 114a determines a mood by analyzing video of customers in the venue. The local server 114a may determine facial expressions and actions for each of the customers using software from, for example, bStable™ or MoodTracker™. The software or additional software operating on the servers 114a and 102 assigns a mood grade to each customer analyzed. The local server 114a then averages the mood grades for each of the customers to determine an average mood or cumulative for the venue. The averaged mood grade can be upgraded or downgraded based upon a separately determined noise grade made via outputs from camera-installed or separate microphones.

The identified attributes include but are not limited to name, birth date, an e-mail address, a phone number, street address, property ownership status, license plate number of a car owned by a customer, type of car owned by a customer, a driving history, criminal history, legal history, tax history, bank information, social security number, credit card information, credit history, relationship status, relationship history, martial status, relatives, family history, product preferences, food preferences, drink preferences, collections, favorites, intelligence level, education, occupation, employment history, salary or income, net worth, investments, religion, purchase history, health history, usernames, passwords, lifestyle association, literature preferences, travel history, allergies, dialects or languages spoken, political preferences, memberships, sport team alliances, hobbies, subscriptions, insurance history, drug history or citizenship status. The local server 114a or the central server 102 can access these attributes from a government or commercial database.

The reports from the venues can also include current environmental information or characteristics, such as, lighting conditions, amount of laughter, weather, temperature, noise, music, line length to enter a venue, crowd patterns, traffic patterns, event based alarms (e.g., a famous person entering a venue, a start of a happy hour, etc.), and pictures or video streams from inside a venue. Environmental data is largely useful to patrons or customers 116 to 120. Venue operators 122 and 124 may also find this information useful. Environmental information could also be useful to third parties 126, e.g., in combination with attribute data. A song played in the venue 106 can be identified using software provided by Shazam™ or SoundHound™ for example. The customer devices 116 to 120 can, for example, display the last five (or some other number) songs played at the venue 106.

The system manager 104, via the central server 102, can create rules based upon collected customer attributes, physical characteristics, and venue environment information. The rules can then be reported to the venue operators 122 and 124 as customer analytics 406. For example, venue 106 may have a roof top deck, a sports room, and a lounge, with each room including a separate detection subsystem, such as subsystem 113a. Central server 102 may determine and report that the number of customers on the roof top deck is determined largely by the weather. The central server 102 can also determine and report that the sports room experiences an increase in customers for local college or professional sporting events. As a result, central server 102 transmits a report to the venue operator 122 showing environmental events correlated with a number of customers and demographics of the customers for the venue 106 overall or for different rooms within the venue 106. The central server 102 can also transmit messages informing the venue operator 122 of an upcoming event, so the operator can plan accordingly.

The system manager 104 receives this information, organizes the information per venue, and analyzes the information for customer contexts, venue operator contexts, and third party contexts. For the customers 116 to 120 and potential customers, the system manager 104 provides scene information 402, which includes summarized real-time venue information and customer demographics.

System manager 104 provides venue operators 122 and 124 with a number of benefits, including branding tools 404, customer analytics 406, and consulting information 408. System manager 104 provides run data or customer reports 410.

Certain of the identified attributes are confidential in nature and not appropriate for viewing by the customers or public at large. Some of the sensitive data could be generalized, relationship status, intelligence, education and income for the entire venue. Other of sensitive information may be useful for public safety. For example, if a percentage of patrons having criminal records reaches a certain level, the venue operators 122 and 124 can be notified (e.g., directly to smart phones(s) of the venue security) and/or a local police force could be alerted. Here, the customer device 116 to 120 can be a computer at a police station or a smart phone for one or more patrolman on duty.

Much of the identified attribute data is useful to third parties 126 (FIG. 1), such as, manufacturers, retailers, distributors and advertisers. Many of these entities can have their own formulas or algorithms for analyzing data to streamline the provision of their products and/or services. The central server 102 can format the attribute data into customized or predefined packets that are then provided to the third parties. The data can be sent on a periodic basis specified by (e.g., most useful to) a particular third party 126.

### Venue Monitoring Subsystems

FIG. 5A illustrates one embodiment of a schematic 500 for an equipment layout of a venue, such as venue 106 of FIG. 1, having detection subsystem 113a and the local server 114a. In this example, venue 106 is any type of club or establishment in which customers gather to socialize. As mentioned before, other subsystems can have different layouts, sizes, purposes, configurations and types of cameras/sensors and other equipment.

Detection subsystem 113a of FIG. 5A includes a traffic flow camera 502 and a demographic recognition camera 504. Cameras 502 and 504 are used to count a number of customers 506, 508, and 510 in the venue 106 and determine demographic information (e.g., physical characteristics) associated with the customers 506, 508, and 510. In the illustrated example, cameras 502 and 504 have already recorded customers 506 who have previously entered the venue 106, Cameras 502 and 504 are currently recording the customers 508 and 510, who have entered the venue.

One or both of the cameras 502 and 504 for any system described herein may additionally be provided with a microphone that records crowd noise, loudness, laughter, talking, yelling, music, etc. Alternatively, any of the systems discussed herein may be provided with one or more separate microphones for recording like sounds. The output of the microphones may be analyzed by the camera if installed on same, or alternatively by the local server 114a in either the camera-installed or separate microphone embodiments.

The traffic flow camera 502 (such as a proximity sensor) is a camera that can sense or detect the presence and relative movement of customers. For example, the traffic flow camera 502 may include two zones of detection to discern which direction a particular customer is moving to determine if the customer is leaving or entering venue 106. To this end, the camera 502 is positioned in proximity to an entryway of the venue 106 to detect customers as they leave or enter the venue, Venue 106 can include multiple traffic flow cameras 502 to periodically court a number of customers in the venue. A suitable traffic flow camera 502 may be provided by, for example, Digiop™, Axis® Communications, SenSource™ Inc, Traf-Sys, ECO-Counter™, Acorel™, Video Turnstil™, Passcheck™, Qmatic™, HeadCounting Systems™, SensMax™, CountWise™, Aimetis™, Flonomics™, or Intellio™, Traffic flow camera 502 can be of any one or more types including standard video cameras, high-definition cameras, infrared cameras, thermal cameras, and three-dimensional cameras.

Demographic recognition camera 504 is used to detect physical characteristics of customers. Camera 504 can include demographic recognition or detection software that analyzes video images to identify physical characteristics of the customers. Alternatively, local server 114a includes the demographic recognition or detection software and performs the identification after receiving video from the camera 504. One suitable camera having associated software for camera 504 is provided by Axis® Communications, Demographic recognition camera 504 may also be provided by other manufacturers and include standard video cameras, high-definition cameras, infrared cameras, thermal cameras, and three-dimensional cameras.

The example local server 114a of FIG. 5A receives count information and video for customer demographic information from the cameras 502 and 504 via any wired or wireless communication medium. After receiving the information, the local server 114a may analyze the video to decipher physical characteristics of the customers. That is, the demographic and recognitive software can be located and programmed in the processor and memory storage of cameras 502 and 504, in the processor and memory of the server 114a, or some combination of both. The local server 114a also, upon an identification of a customer using the demographic recognition or detection software, accesses databases of customer attributes or profile information and links this information to the identified customer. In some embodiments, customers may create profiles to configure preferences, check-ins, favorites, and provide comments. In these embodiments, the central server 102 uses this voluntary information provided by the customers with real-time information associated with the customers recorded by the subsystem 113a to compile valuable customer data.

The local server 114a may also collect real-time venue information or use video recorded by the camera 504 to determine real-time attribute and/or environmental information discussed above. For example, the local server 114a may analyze received video to determine a lighting characteristic of the venue 106. Local server 114a may analyze audio recorded by the camera 504 to identify types of music being played in the venue 106 or a loudness characteristic of the customers 506. After collecting, analyzing, and processing real-time customer and venue information, local server 114a then stores this information to a time-stamped record and transmits this record to the central server 102.

FIG. 5B shows a single camera 505 that both (i) provides demographic recognition and (ii) monitors traffic flow. In this alternate example, camera 505 includes the capability to provide the combined functionality described in connection with the cameras 502 and 504 of FIG. 5A. Alternatively, the camera 505 records video images of the customers in venue 106, and local server 114a or the central server 102 includes software that (i) counts a number of customers entering or leaving the venue 106 and (ii) uses physical facial or body recognition algorithms to determine demographics of the customers.

Camera 505 may alternatively include radio frequency (“RF”) detectors or sensors that sense signals emitted from smartphones, cellphones, or other mobile devices of the customers. Camera 505 may be provided by, for example, Path Intelligence™ based on their Footpath™ technology. In this example, the camera 505 detects a number of customers based upon the number of signals from different mobile devices in the venue 106. For example, each mobile device may be associated with a unique identifier coded within emitted signals. The local processor 114a or the camera 505 determines an identity of each of the customers based on information within the signals (such as a wireless identifier associated with the mobile device). The local processor 114a references the identity to attribute or physical characteristic information for each of the customers. In this manner, the camera 505 and the local processor 114a are able to determine a count of customers and demographic data associated with the customers without actually visually recording or monitoring the customers.

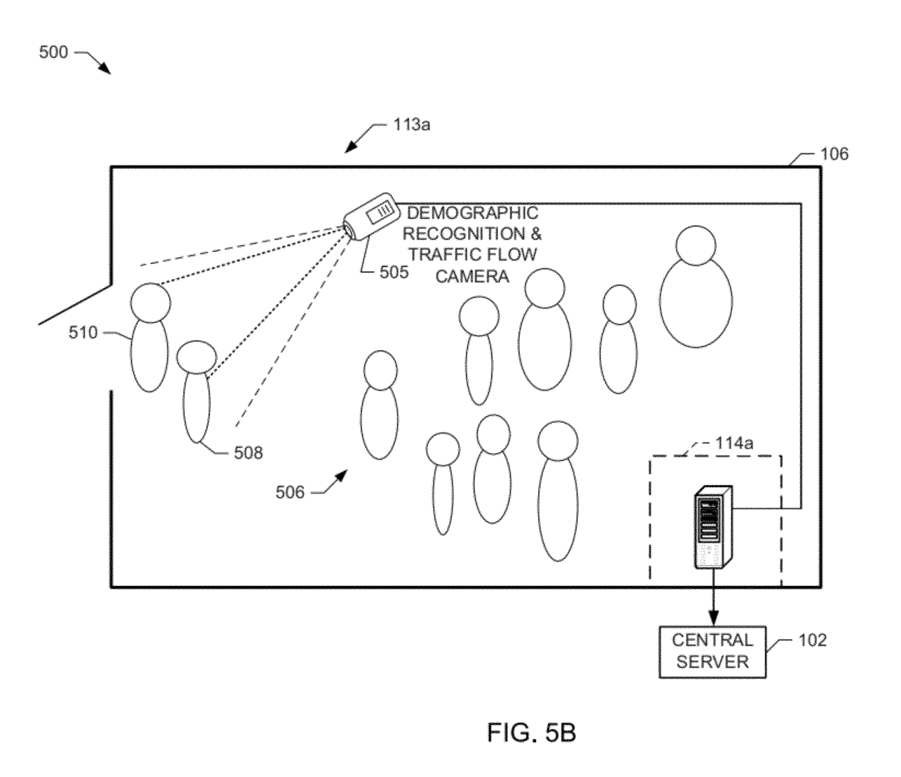

FIG. 6 shows a demographic recognition or detection analysis performed by local server 114a or the demographic recognition camera 504 of FIG. 5A. In this example, the camera 504 detects customers 508 and 510 who have walked through the door of venue 106 and have entered a zone of interest 600. The zone of interest 600 is created when the camera 504 is setup and is positioned to record customers entering the venue 106. Customers 508 and 510 are counted by traffic flow camera or sensor 502. The venue count is updated at server 114a accordingly. While a camera 502 is used for counting in one embodiment, a sensor 502 may be used additionally or alternatively. The sensor 502 can be a photo-electric sensor, for example, having a separate emitter and receiver or an emitter/receiver in one housing that operates with a reflector. In either situation, a beam of light is broken by a patron, increasing or decreasing the venue count by one depending upon whether the patron is entering or leaving the venue. The sensor can be used in place of the camera or provide a redundant count to double check camera 502. In this latter example, if the counts disagree, the algorithm can be programmed to select the count that results in a lower total number of patrons in the venue.

Camera 502 allows two people walking into zone 600 at the same time, whereas sensor 502 may not be able to discern same. Camera 102 can also discern whether a patron is arriving or leaving. For example, camera 102 can photograph a patron at two points in time. If patron 508 consumes more space within zone 600 in the second snapshot, the patron 508 is taken as heading towards camera 102 or entering venue 106. The converse is true for patron 508 leaving venue 106. Thus, the camera 502 is likely a more accurate solution than a sensor. But for a particular venue, for example, one that largely produces separate, single file lines entering and leaving the venue, a proximity sensor 502 may suffice.

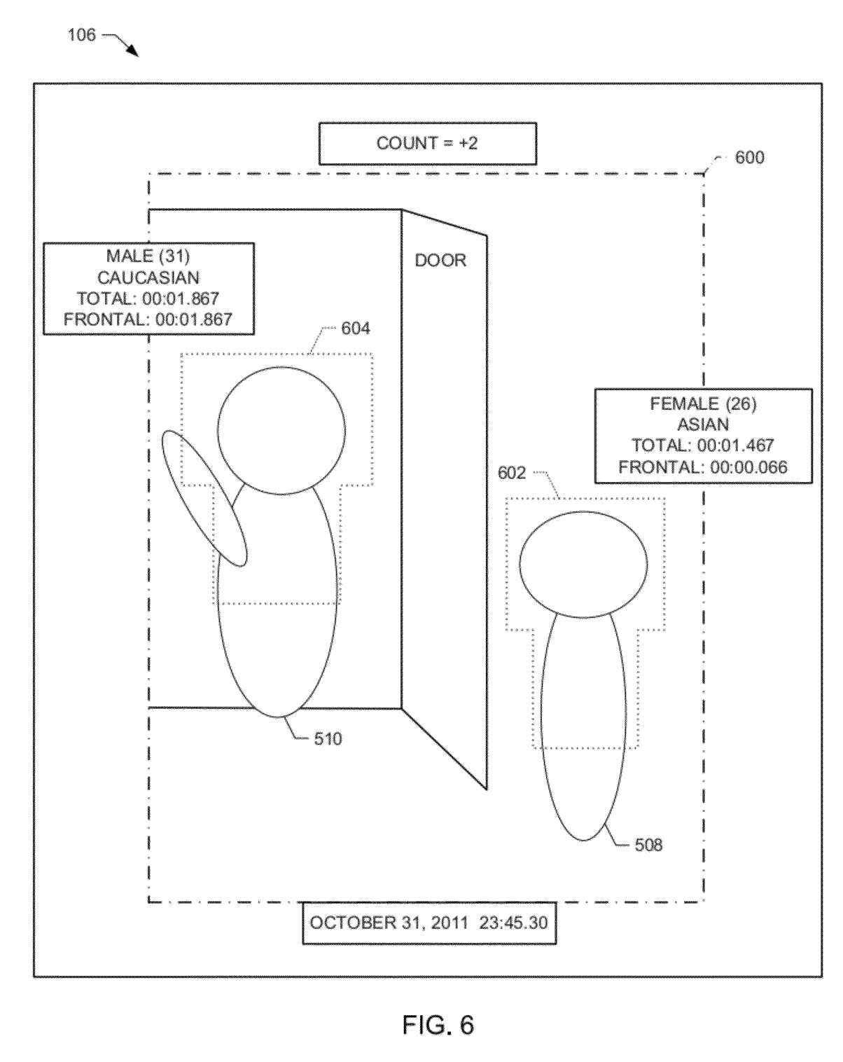

Alternatively, the camera 502 can be placed overhead of the zone 600 as described in connection with FIG. 7. In that embodiment, two snapshots of the same patron 508 moving in a first direction into the venue 106 is considered to be a person entering the venue, while two snapshots of the same person moving in a second direction out of the venue 106 is considered to be a person leaving venue 106.

In the illustrated example, the demographic recognition camera 504 detects the customer 508 entering. The camera 504 then creates an analysis area 602 overlaid upon a video image of the customer 508. The camera 504 similarly detects the customer 510 and creates an analysis area 604. The analysis areas 602 and 604 are regions of interest in a video image that are analyzed by demographic or facial recognition software to identify physical characteristics of the customers 508 and 510. The camera 504 moves the areas 602 and 604 in video images to correspond to movement by the customers 508 and 510 so that the recognition software has multiple video images to identify physical characteristics. The multiple images may provide different angles and lighting conditions that help the recognition software perform the identification.

In this example, the recognition software uses the video of the analysis area 602 to determine that the customer 508 is a 26 year old female of Asian ethnicity. Additionally, the recognition software uses the video of the analysis area 604 to determine that the customer 510 is a thirty-one year old male of Caucasian ethnicity. The TOTAL and FRONTAL parameters correspond to a quality of the demographic detection or recognition based on lighting conditions and how much area (e.g., frontal facial area) of the customers 508 and 510 the camera 504 was able to record. These parameters may be used by the local server 114a for data correction for instances where the quality of the video may be relatively low (from obstructions, lighting, smoke, etc.).

Parameters, such as age and ethnicity, may be sophisticated guesses that have a certain margin for error. Thus, a recognition software determination that customer 510 is thirty-one years of age can be categorized in a range, such as a three-year, five-year or eleven-year range, e.g., 29.5 to 325, twenty-nine to thirty-three or twenty-six to thirty-six. The ranges have progressively increasing accuracy but large span.

FIG. 7 shows a side-perspective view of the detection system 113a of FIG. 5A. The illustrated example shows one preferred position for the cameras 502 and 504 in the venue 106. As mentioned before, different configurations and positioning may be dictated by the layout of the venues or based upon a preference of the venue operator. For example, a venue with multiple entrances may require multiple sets of cameras 502 and 504. A venue with multiple floors may require dedicated sets of the cameras 502 and 504 on each floor. In a particular example, an Italian restaurant may have three separate rooms each dedicated to a different region in Italy. Each of the rooms may have their own set of cameras 502 and 504. In this example a website or smartphone application associated with the system 100 can be configured to compile total customer data for the restaurant and/or to partition the customer data for each of the separate rooms. For instance, a first room could have a scene of “lively,” a second room could have a scene of “chill,” and a third room could have a scene of “social.”

In the example of FIG. 7, the traffic flow camera 502 is located from about eight feet to about fifteen feet (2.4 meters to 4.6 meters) above the floor of venue 106 and approximately one foot (30.5 centimeters) away from the doorway of the venue 106. The camera 502 faces downwardly to detect customers as they enter the venue 106. The demographic recognition camera 504 is located from about five feet to about fifty feet (1.5 meters to 15 meters) from the doorway and is positioned to face customers as they enter the venue 106. Camera 504 is positioned so that a viewing angle includes at least the faces of the customers as they enter venue 106. In the illustrated example, a mounting member 702 couples camera 504 to the ceiling of venue 106 to achieve desired viewing angle. Alternatively, the camera 504 may be attached to a wall, beam, pipe or other structure of venue 106.

In other examples, any one of the cameras 502 and 504 may be positioned outside of the venue 106, e.g., in an adjacent room or hallway, or in another other area that provides enough visibility to record and identify demographic or physical characteristics of customers such as customer 508. Further, cameras 502 and 504 may include lighting sources or other image modification components to enhance video quality. For example, the camera 504 may include an infrared light to provide additional lighting exposure or an infrared detector to provide additional customer views and/or resolution to determine the customer demographic information.

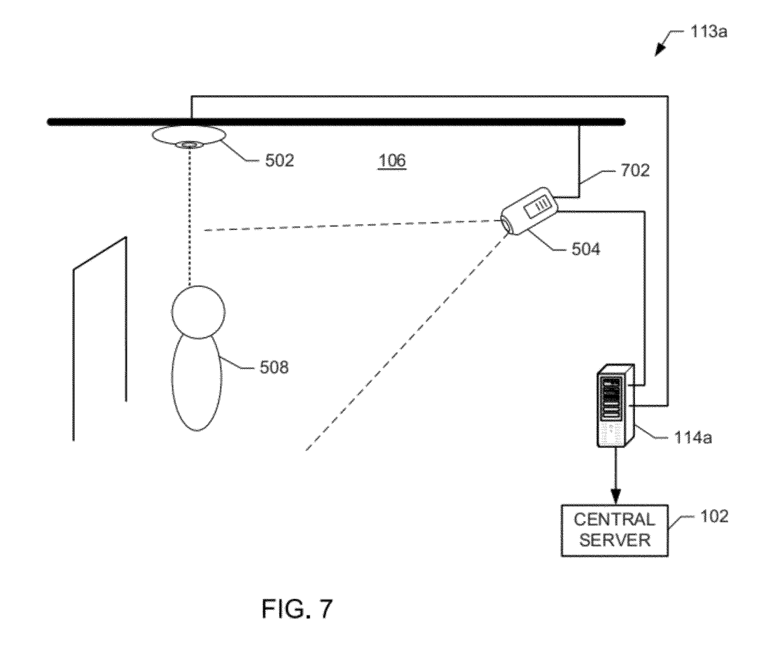

FIG. 8 shows a side schematic view of the venue 106 with an alternative demographic recognition configuration, using additional camera 804 along with camera 504 for detection subsystem 113a. In this example, the camera 804, mounted via an adjustable mounting member 802, is used to determine demographic or physical characteristics of customers as they exit the venue 106. This second camera 804 enables local processor 114a to update real-time information to reflect not only a number of customers who have left the venue 106 but also the demographics of the customers who have left the venue. The demographics may be general, e.g., male versus female, age, ethnicity, etc., or may actually identify which of the customers has left through identity racial recognition. In the illustrated example, the traffic flow camera 502 detects customers leaving and entering. Additionally, the camera 504 detects the customer 510 entering (see arrow), while the camera 804 detects customer 508 leaving (see arrow) the venue 106.

The ability to actually identify a person using a camera, such as camera 504 or 804, may be achieved via facial detection software provided by, for example, Intel AIM Suite™, Intellio™, Luxand™, or Apple™. The ability to actually identify a person using a camera, such as camera 504 or 804, may be achieved via, facial recognition software provided by Facebook™, Google™, PittPatt™, Windows Live™, Picture Motion Browser™, iPhoto™, or Picasa™. Once the customer's identity is known, personal attribute data for the customer can be achieved by the systems described herein via other databases, such as social websites, work websites, searchable web pages, and the like.

In an embodiment, the facial detection software uses algorithms to determine what a customer looks like through physical characteristic analysis or through a matching program that utilizes existing data to match a recorded facial or body image to generic faces or body types stored in a database. The facial detection software determines, for example, that a customer is a twenty-eight year old male. The facial recognition software uses image databases (such as Facebook™ or government databases) to match a recorded image to an image in one of these databases to determine an identity of a customer in the image. In this example, the facial recognition determines that a customer is, for example, John Smith.

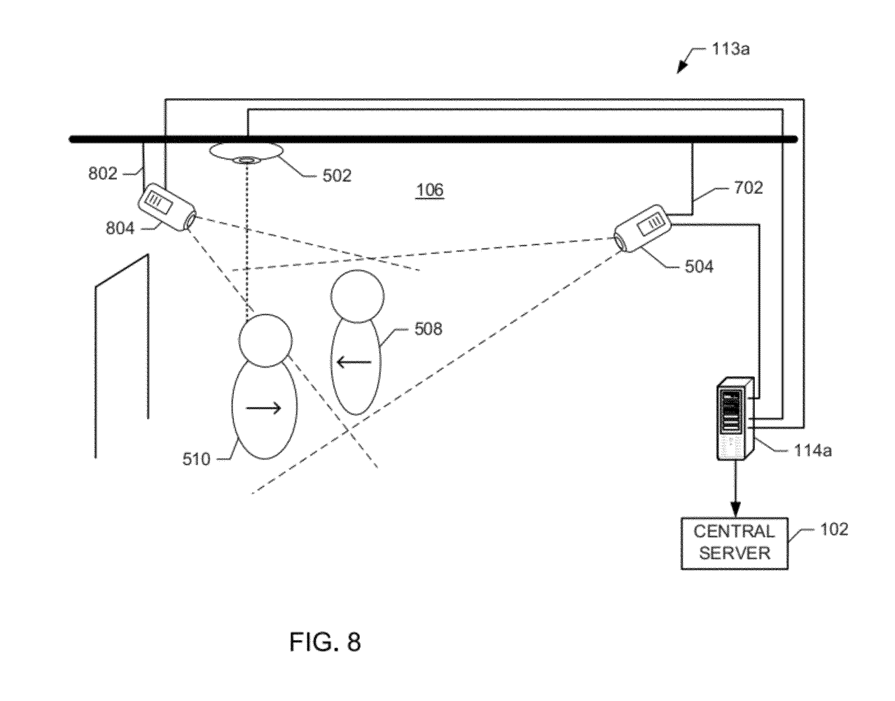

FIG. 9 shows amide schematic view of the detection system 113a in the venue 106 with an integrated camera 902. In this example, the integrated camera includes multiple tenses that simultaneously count customers 506 in the venue 106 and detects and/or recognizes demographics or physical characteristics of each of customers 506. The integrated camera 902 is positioned in a central location within the venue 106 to track and record all of the customers 106, including customers entering and leaving. The integrated camera 902 may include a 360° camera that scans all customers constantly throughout venue 106 without having to rotate or move.

Local processor 114a my use video from the integrated camera 902 to identify movements of the customers 506 to help identify a trend of the venue 106. For example, the local processor 114a may determine the venue 106 is ‘dance-crazy’ if it detects that many of the customers 506 are vigorously moving. In another example, the local processor 114a may determine the venue 106 is ‘chili’ if the processor 114a detects that customers 506 are relatively stationary and/or seated. Further, the integrated camera 902 may include components, e.g., microphones or light meters to centrally detect light intensity, music, and/or noise in the venue 106.

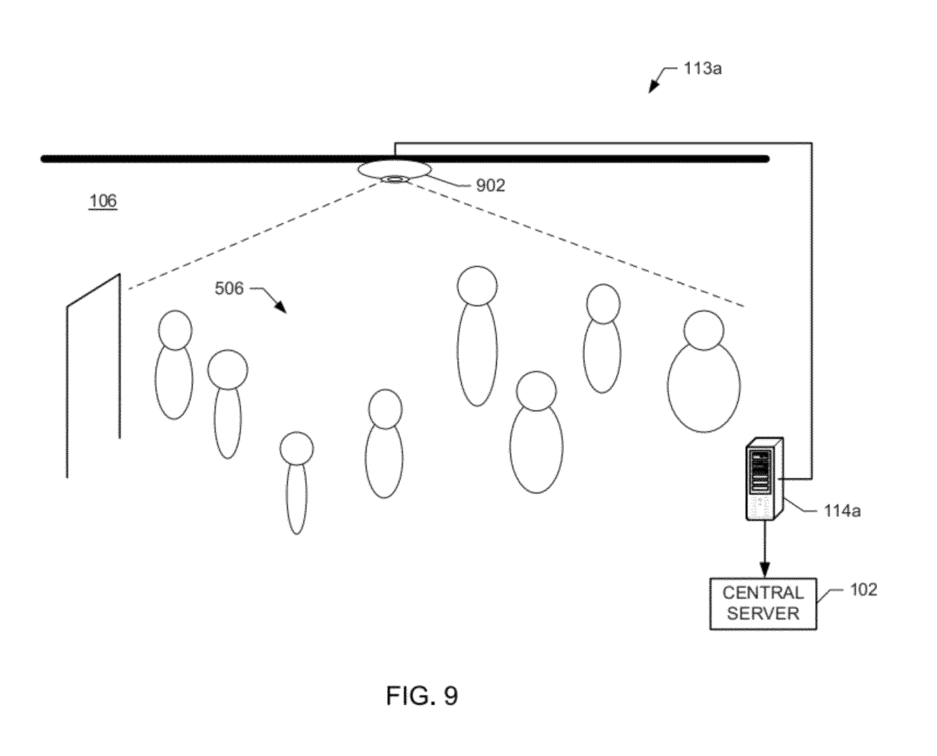

FIG. 10 shows local server 114a of the venue 106 communicatively coupled to the cameras 502 and 504 (also connected to central server 102 as shown above). In this example, CAT5 cable connects the cameras 502 and 504 to a Power over Ethernet (“POE”) switch 1002. The example POE switch 1002 provides power to the cameras 502 and 504 via respective ports. Additionally, the POE switch 1002 routes data from the cameras 502 and 504 to the local server 114a and routes data from the local server 114a to a gateway 1004. The gateway 1004 is connected to an Internet source (e.g., the network 112 of FIG. 1), which enables the local server 114a to communicate with the central server 102. The gateway 1004 converts communications from the local server 114a into a format compatible for transmission to the central server 102 via the network 112.

In this example, CAT5 cable is used to improve the quality of visual images recorded by the camera 504 and to improve analytics conducted by the local server 114a. The CAT 5 cable also provides for relatively quick data transfer speeds and relatively secure data transfers between POE switch 1002, cameras 502 and 504, the local server 114a and the gateway 1004. Alternatively, the CAT5 cable can be replaced by a wireless network. Here, cameras 502 and 504, the POE switch 1002, the local server 114a, and the gateway 1004 communicate via any wireless medium and protocol.

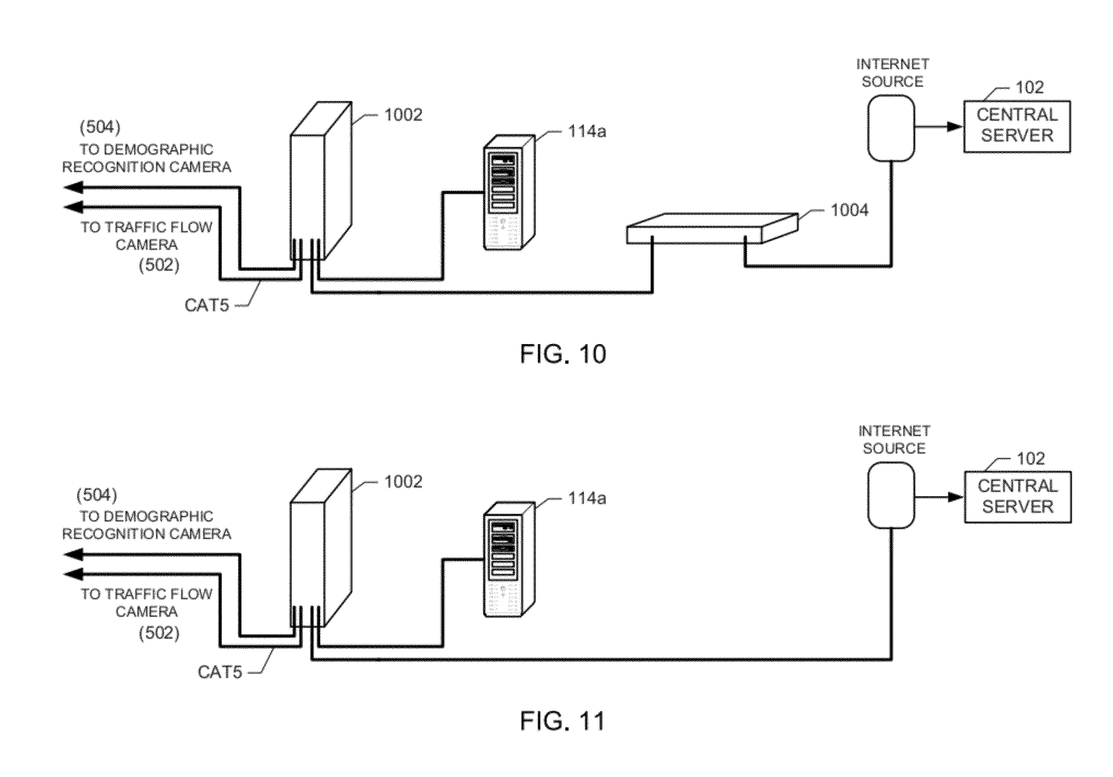

FIG. 11 shows local server 114a of the venue 106 communicatively coupled to the Internet source via the POE switch 1002. Here, POE switch 1002 also functions as gateway 1004 of FIG. 10 for communication between the local server 114a and the central server 102. While the illustrated example shows cameras 502 and 504 coupled to the POE switch 1002, in other examples, a non-POE compliant camera or other detection devices can be communicatively coupled directly to the local server 114a or, alternatively, a router or hub. Further, in instances in which local server 114a is not implemented in venue 106, cameras 502 and 504 may be directly connected to the Internet source. Here, cameras 502 and 504 include functionality that enables the cameras 502 and 504 to communicate with the central server 102 via, the network 112.

In yet other instances, cameras 502 and 504 may be communicatively coupled to application programming interfaces (“APIs”) via the network 112. In these instances, the APIs are hosted in a cloud platform that provides central processing for facial or demographic identification from one or more venues. Here, the cloud computing may replace the functionality provided by the local server 114a and the central server 102.

### Venue Operator Context Applications

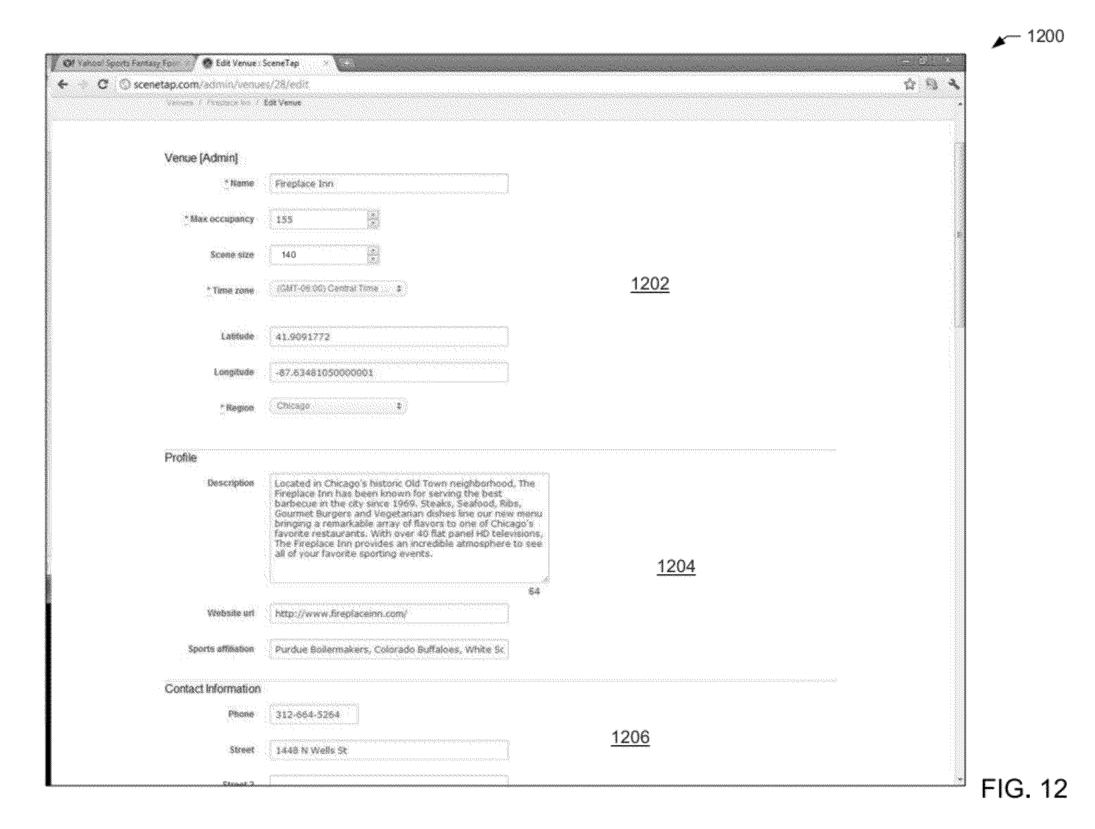

FIGS. 12, 13, and 14 illustrates example registration interfaces 1200, 1300, and 1400, respectively that prompt, for example, venue operator 122 for information regarding the venue 106, Central server 102 prompts venue operator 122 for the information when the venue operator 122 requests that venue 106 be part of the venue monitoring environment 100 of FIG. 1. The registration interfaces 1200, 1300, and 1400 show certain information that the venue operator 122 can provide. In other examples, the registration interfaces 1200, 1300, and 1400 can include additional information (such as billing information or information about the detection subsystem 113a installed in the venue 106).

In the illustrated example, the registration interface 1200 of FIG. 12 includes a first section 1202 including general information regarding the venue 106, a second section 1204 including profile information associated with the venue 106, and a third section 1206 including contact information for the venue 106. The first section 1202 includes a name, venue occupancy and scene size limits, a time zone, and a location of the venue 106. The venue occupancy limit corresponds to a maximum number of people legally allowed in the venue 106 and the scene size limit is a maximum venue occupancy based on a perspective of customers (such as how crowded a venue feels to customers). The second section 1204 includes a description of the venue 106, a website operated by the venue 106, and sports affiliations associated with the venue 106. The third section 1206 includes an address of the venue 106.

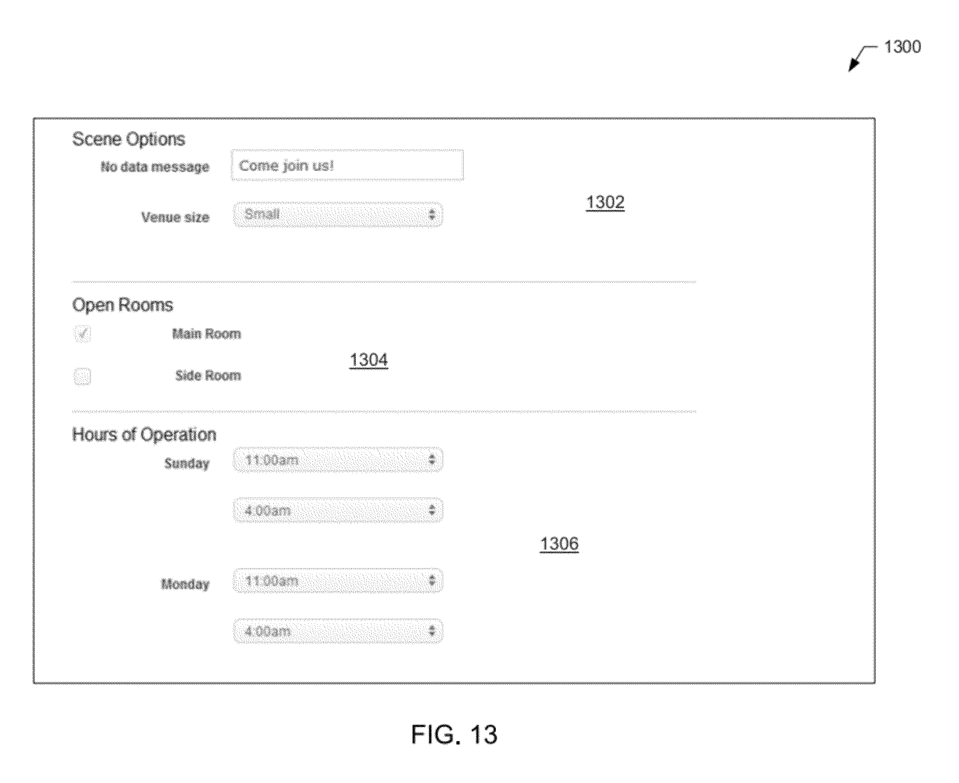

In FIG. 13, the registration interface 1300 includes sections 1302, 1304, and 1306. The first section 1302 includes customer scene information regarding the venue 106. The second section 1304 includes information regarding specific rooms in the venue 106. The third section 1306 includes hours and days of operation of the venue 106.

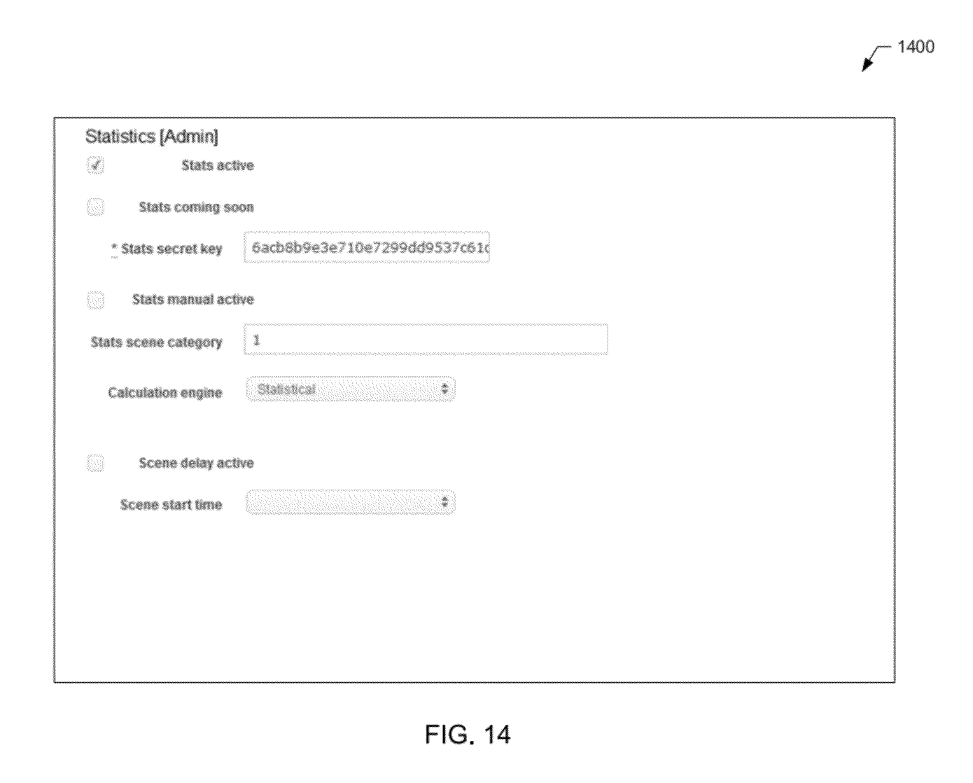

In FIG. 14, the registration interface 1400 includes information regarding how the venue operator 122 would prefer to view history and real-time information collected and processed by the central server 102. For example, the venue operator 122 can select different calculation engine options to specify how the central server 102 is to process data collected from the venue 106. The venue operator 122 can also specify times during which the central server 102 is to collect and process data from the venue 106. Further, venue operator 122 can provide security credentials or log-in information that the venue operator 122 uses to access the collected and processed data provided by the central server 102.

In other examples, the registration interface 1400 can also include an alert section. In these other examples, venue operator 122 can specify conditions or thresholds based upon collected and analyzed data. The central server 102 uses these alerts to monitor the real-time venue information and customer demographic data to determine when a notification message is to be sent to the venue operator 122. For example, the venue operator 122 may request to receive a message when the venue 106 is at eighty percent of capacity. In response to receiving a message, the venue operator 122 may increase a number of staff working at the venue 106 to accommodate the relatively large crowed.

### Customer Context Applications

FIGS. 15 to 18 show example customer viewable context applications 1500, 1600, 1700, and 1800 displaying real-time venue information and customer demographic information. Customers access the customer context applications 1500 to 1800 using, for example, the customer devices 116 to 120 in FIG. 1. FIGS. 15 to 18 show some example implementations of the central server 102 displaying real-time venue and customer information. In other examples, the customer context applications 1500 to 1800 can include additional or less information (such as information regarding summarized or specific customer attributes and physical characteristics or venue scene information described in conjunction with FIG. 4).

The customer context application 1500 of FIG. 15 shows real-time customer demographic data and venue information for the Vertigo Sky Lounge venue displayed in a webpage. The central server 102 updates this information periodically so that customers or potential customers who access this application 1500 view the most recent venue and demographic information. The customer context application 1500 is displayed by the central server 102 for the venue monitoring environment 100 and is separate from a website hosted and managed by a venue operator. The customer context application 1500 may be integrated, for example, with a website hosted by the venue operator.

In the illustrated example, customer context application 1500 includes sections 1502, 1504, 1506, and 1508 that display venue information provided by a venue operator using, for example, the registration interfaces 1200 to 1400 of FIGS. 12 to 14. Section 1502 includes a location on a map of the venue. Section 1504 includes an address, phone number and hours of operation of the venue. Section 1506 includes links to directions and a website operated by the venue. Section 1508 shows a service mark or logo associated with the venue. Customer context application 1500 also includes a section 510 that shows specials that a venue operator can specify to be shown at particular times or based on analyzed real-time venue information. For example, central server 102 displays the “Deals for October 31:” offer created by the venue operator when it detects that the venue is less than 40% of capacity on October 31.

Customer context application 1500 also includes a section 1512 that displays comments from customers. In some instances, the comments are provided by customers after they have visited the venue (such as reviews). In other instances, the comments may include status updates or tweets from customers who are currently at the venue. For example, the central server 102 can access social media applications to retrieve comments posted by users that reference the venue.

The example customer context application 1500 further includes a section 1514 that provides real-time venue and customer demographic information. The example central server 102 periodically updates this information (such as every few minutes) based on newly received information from the venue. In this example, the section 1514 shows the venue is at thirty-four percent of capacity, that during the past thirty minutes the number of customers in the venue has decreased by two, the ratio of males to females is 62/38, and the average age or age range of the customers is thirty. The section 1514 also shows that the venue has a “social” mood. The central server 102 determines the mood based, at least on part on real-time venue information including noise level and a number of customers in the venue.

The section 1514 can also show trend information for the venue 106. For example, the central server 102 can determine a rate at which customers are entering a venue by comparing count data for subsequent time periods. The central server 102 then displays in the section 1514 an indicator as to the rate of customers are arriving at the venue 106. For example, if the central server 102 determines fifty customers entered the venue between 6:00 P.M. and 6:30 P.M., the central server 102 displays an indicator in the section 1514, e.g., “This place is heating up!”. The central server 102 could also display that customers are “arriving” or “leaving,”

In other instances, the customer context application 1500 can include a section that enables current customers in the venue to post questions or recommendations for the venue operator. The central server 102 receives the questions or recommendations and transmits them to the venue operator or personnel at the venue. For example, the customer context application 1500 may receive a request to change a type of music being played in a venue or a request for a particular song. In this example, the central server 102 determines the request is associated with music and transmits a notification with the request to a disk jockey (“DJ”) or appropriate venue personnel. In other instances, the customer context application 1500 may enable customers to directly select the music to be played at the venue, e.g., for an application fee.

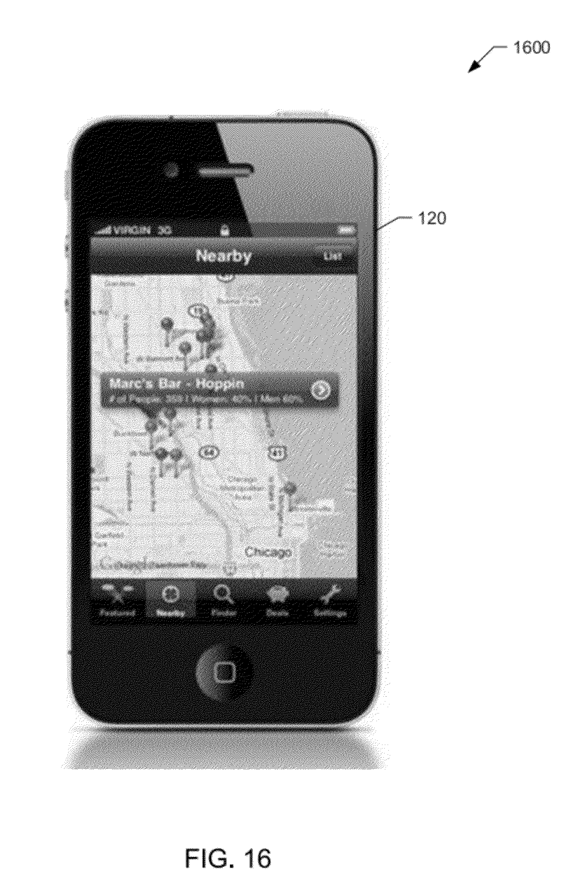

FIG. 16 shows the customer context application 1600 being displayed by the customer device 120 (such as a smartphone). In this example, the customer context application 1600 shows results depicted on a map of venues that are in proximity to the customer device 120. The central server 102 transmits the results to the customer device 120 based on received search criteria. In other examples, the search criteria can include a mood, a percent of capacity, a ratio of males to females, an average age, or any other attributes, physical characteristics, or venue information processed by the central server 102. The search criteria can also include a venue selection, which causes the central server 102 to identify other venues in proximity to the entered venue. In another venue selection, the central server 102 identifies and displays other venues that are of a same type, e.g., night clubs similar to the entered venue.

In the illustrated example, the customer context application 1600 also shows real-time venue information and customer demographic data. For example, a user of the customer device 120 selects a venue shown on the map, thereby causing central server 102 to transmit the name of the venue (e.g., Marc's Bar), a mood of the venue (e.g., hoppin), a number of people in the venue, and a ratio of males and females. This information provides the customer with a snap-shot of a scene at the selected venue without the user having to search other websites or contact people. The user can quickly select other venues on the map to view similar types of information to determine which venue to attend. The customer context application 1600 also enables a user to select a venue to view more information, such as the information described in conjunction with FIG. 15.

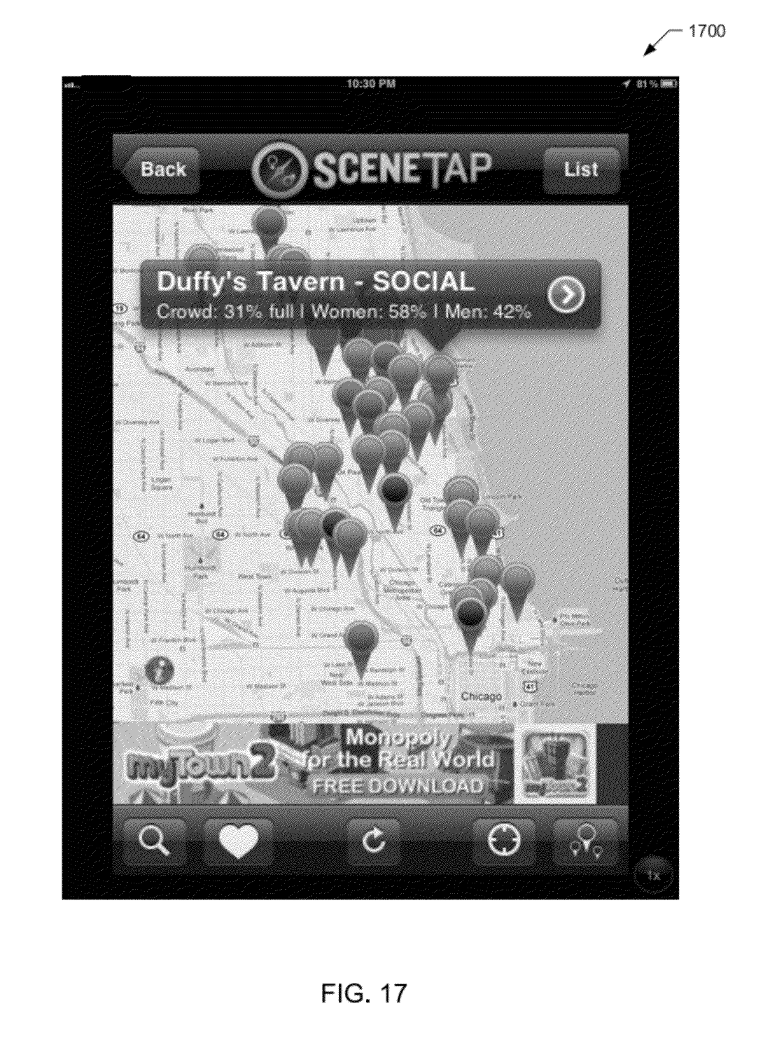

FIG. 17 shows the customer context application 1700 for a mobile device (such as customer device 120), similar to the customer context application 1600 of FIG. 16. In this example, the customer context application 1700 shows icons on a map depicting locations of venues based on a search conducted by central server 102. In the illustrated example, the customer context application 1700 shows the icons as different colors based upon a mood of a venue. A legend can be displayed if desired. For example, the customer context application 1700 shows a dark color for venues that are closed or relatively empty, a medium color for venues with a “social” mood, and a very light color for venues with a “hoppin” mood. Thus, the customer context application 1700 can display moods of multiple venues in an easily readable manner.

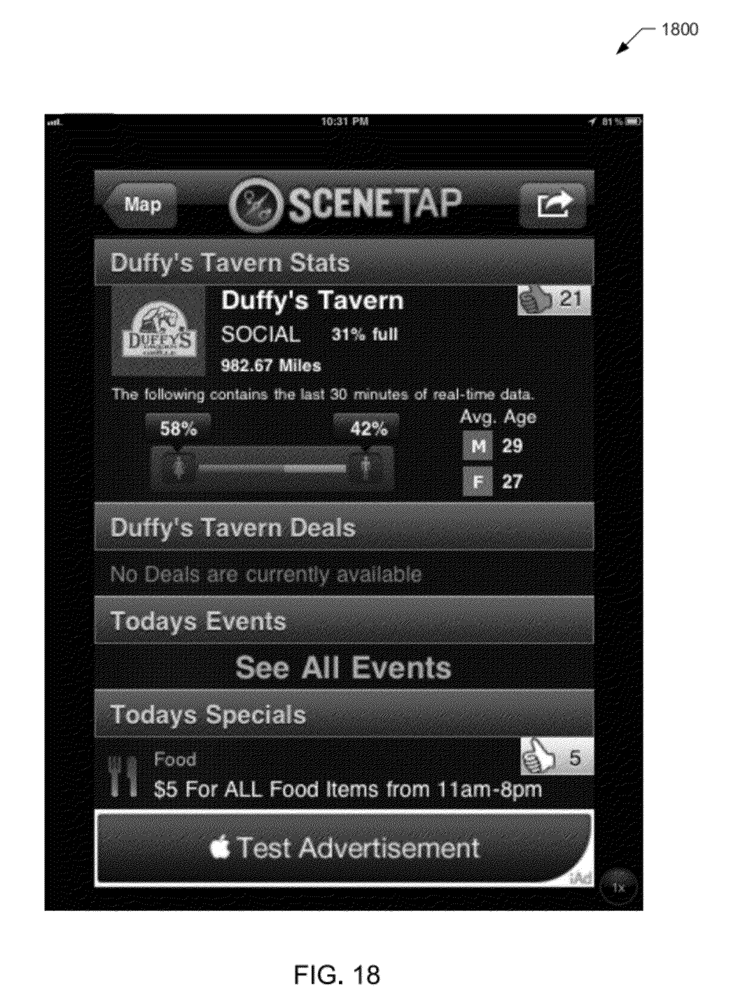

FIG. 18 shows the customer context application 1800 displaying additional venue information formatted for customer device 120. In this instance, a user selects a link to view more information regarding Duffy's Tavern displayed in the customer context application 1700 of FIG. 17. After selecting the link, the central server 102 sends real-time venue information and customer demographic data to the customer device 120 for display via the customer context application 1800. The information in FIG. 18 is similar to the information described in conjunction with FIG. 15 but is formatted for a smaller display of a mobile device.

### System Manager Context Applications

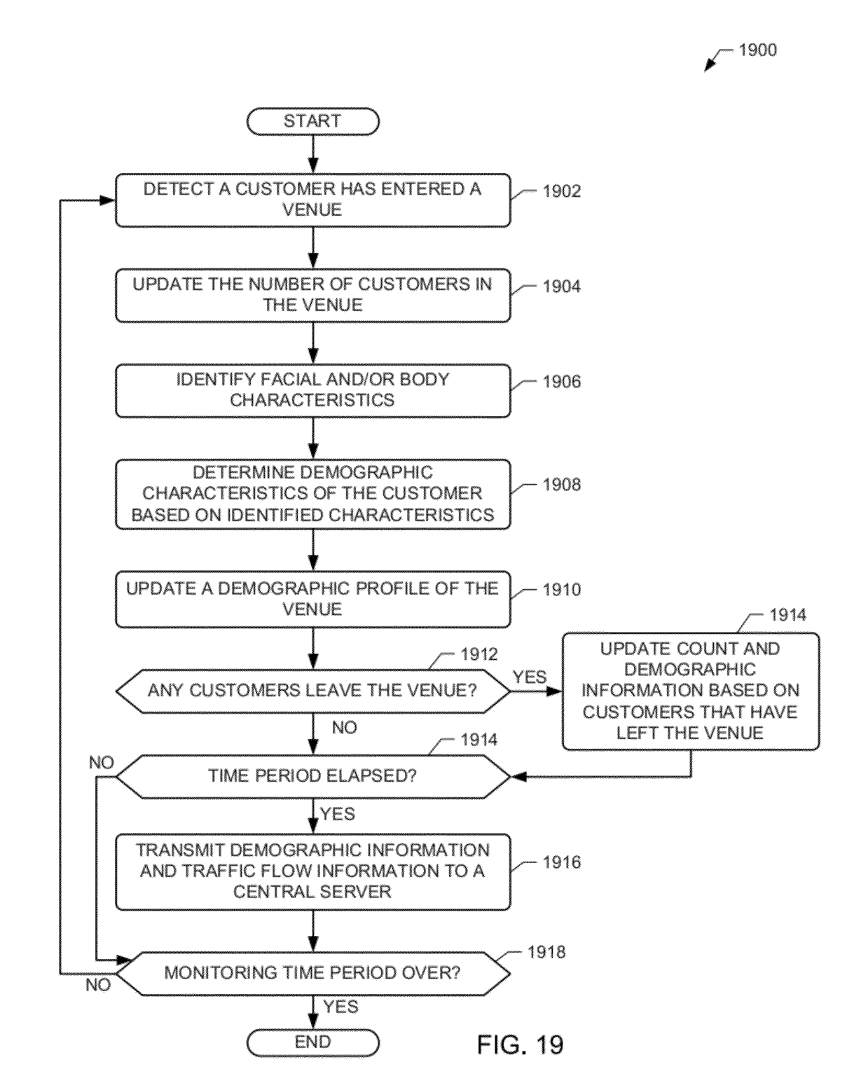

FIG. 19 shows an example flowchart of a process 1900 to collect real-time venue information and customer demographic data in, for example, the venue 106 of FIGS. 1 and 5. At START, the process 1900 begins by the traffic flow camera 502 detecting that a customer has entered the venue 106 (block 1902). The local processor 114a updates a number of customers in the venue 106 by accounting for the newly entered customer (block 1904).

The local processor 114a then uses video from the demographic recognition camera 504 to identify physical facial or body characteristics of the newly entered customer (block 1906). In some examples, the local processor 114a determines physical characteristics by matching an image of the newly entered customer to millions of images of facial and/or body characteristics stored in a database. The local processor 114a next uses the physical characteristics to determine demographic characteristics of the newly entered customer (block 1908). The local processor 114a ma also determine attributes associated with the customer.

The local processor 114a then updates a demographic profile of the venue 106 with the demographic data associated with the newly entered customer (block 1910). In some examples, the local processor 114a updates the demographic profile by updating a count of different demographic categories. For example, the code blow shows demographic categories that may be tracked for the venue 106. In this example, the demographic categories of “m_age_older_count” and “male_count” listed below can be updated based on the newly entered customer being a 40 year old male.

“venue_id”:0,
“venue_secret”:“0”,
“interval”:0,
“data”:{

“timestamp”:“2011-12-06T16:28:43”,
“count_in”:0,
“count_out”:0,
“f_age_unknown_count”:0,
“f_age_child_count”:0,
“f_age_teen_count”:0,
“f_age_young_count”:0,
“f_age_older_count”:0.
“f_age_senior_count”:0,
“m_age_unknown_count”:0,
“m_age_child_count”:0,
“m_age_teen_count”:0,
“m_age_young_count”:0,
“m_age_older_count”:1,
“m_age_senior_count”:0,
“u_age_unknown_count”:0,
“u_age_child_count”:0,
“u_age_teen_count”:0,
“u_age_young_count”:0,
“u_age_older_count”:0,
“u_age_senior_count”:0,
“unknown_count”:0,
“female_count”:0,
“male_count”:1

}

In one example, local processor 114a determines if any customers have left the venue 106 based upon information provided by the traffic flow camera 502 (block 1912). If customers have left, the local processor 114a updates count and/or demographic information based on the customers that have left the venue 106 (block 1914). The local processor 114a then determines if a time period for transmitting data to the central server 102 has elapsed (block 1916). If the time has elapsed, the local processor 114a transmits the customer demographic data to the central server 102 (block 1918). The local server 114a may also transmit real-time venue information including temperature, noise and light levels, humidity, etc. The local server 114a then determines if a time period for monitoring the venue 106 has elapsed (such as when the venue 106 closes). If the time period has not elapsed, the local server 114a returns to detecting if customers have entered the venue 106 (block 1902). If the time period has elapsed, the example process 1900 ends as illustrated. In some examples, local processor 114a may compile and analyze customer demographic data in parallel. In these examples, the local processor 114a may operate process 1900 multiple times for different instances of time.

### Third Party Context Applications

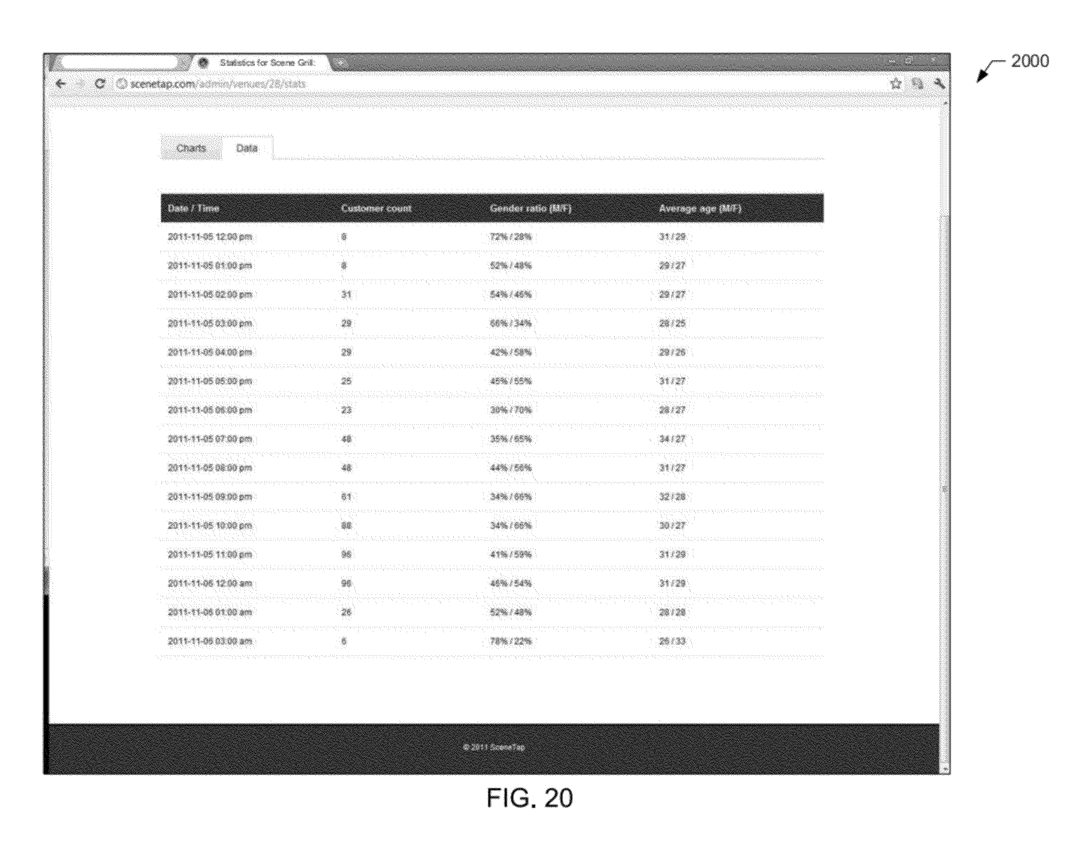

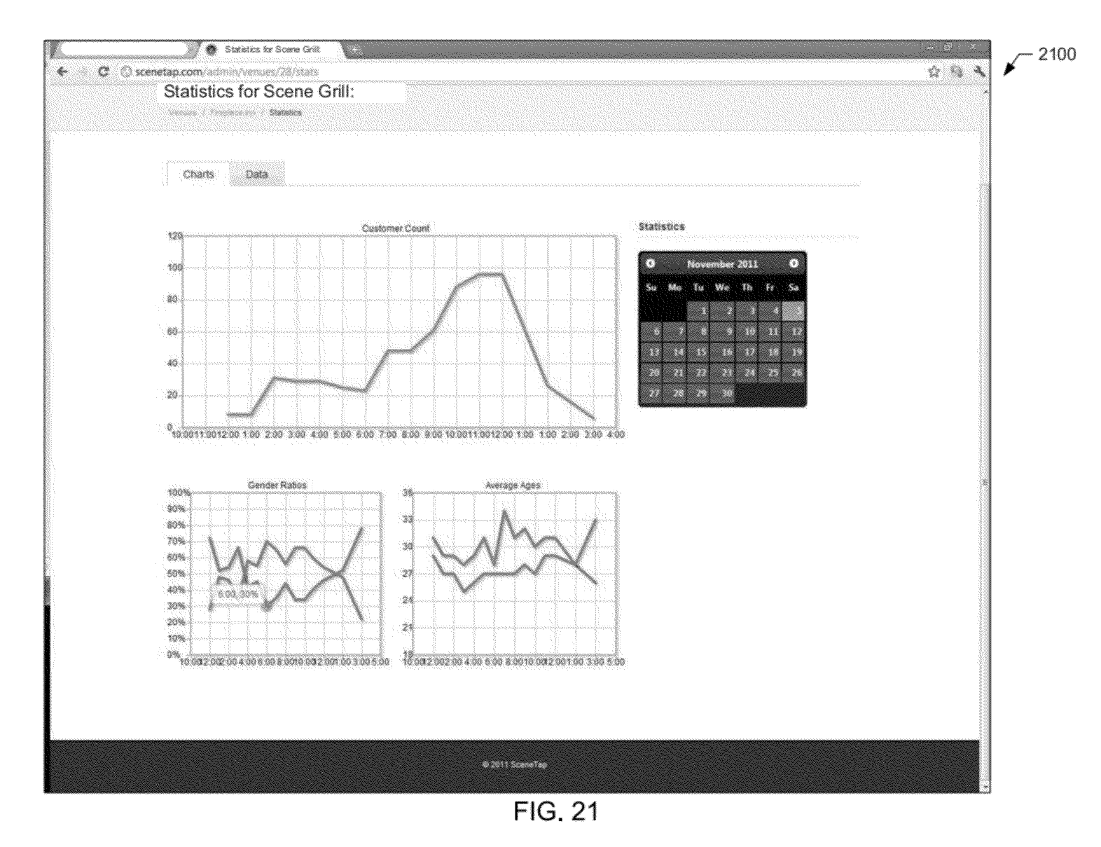

FIGS. 20 and 21 illustrate third party context applications 2000 and 2100 created by the central server 102 having demographic histories, e.g., for venue 106. The third party context application 2000 and 2100 can be webpages that third parties 126 or venue operators 122 and 124 access to view compiled demographic history data for the venue 106. In some instances, the third party context applications 2000 and 2100 can only be accessed by the venue operator 122 associated with the venue 106. In other instances, the third parties 126 can access the applications 2000 and 2100 after subscribing to a data service associated with the venue monitoring environment 100.

The third party context application 2000 includes a history of a number of customers, a gender ratio, and an average age of each gender for the venue 106. In this example, third party 126 can use this information to determine at which time(s) that the venue 106 is the most crowded on a given evening and the demographic breakdown of these people for target marketing. Additionally, the venue operator 122 can use the information in the third party context application 2000 to determine trends of past customers to plan future operations. In other examples, the third party context application 2000 can include any of the attributes or physical characteristics described in conjunction with FIG. 4.

The third party context application 2100 of FIG. 21 includes graphical histories, plots or trends of a number of customers, a gender ratio, and an average age of each gender for the venue 106 in a given day. The third party 126 or the venue operator 122 can select a day on the calendar to view demographic history data for that day. Similar to the third party context application 2000, the third party context application 2100 enables third parties 126 and the venue operator 122 to review past demographic data to plan future operators or provide target marketing.

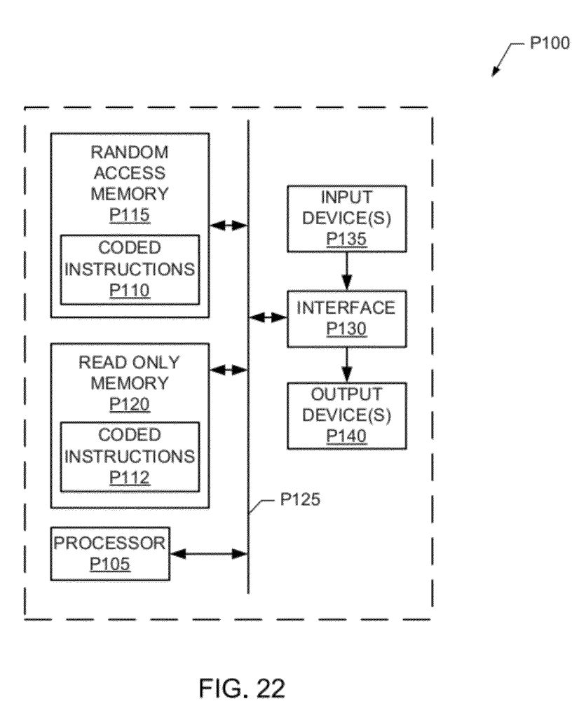

FIG. 22 is a schematic diagram of an example processor platform P100 that may be used and/or programmed to implement the example local servers 114a and 114b and/or the example central server 102 of FIGS. 1, 5, and 7 to 11. For example, the processor platform P100 can be implemented by one or more general-purpose processors, processor cores, microcontrollers, etc.

The processor platform P100 of the example of FIG. 22 includes at least one general purpose programmable processor P105, The processor P105 executes coded instructions P110 and/or P112 present in main memory of the processor P105 (e.g., within a RAM P115 and/or a ROM P120). The processor P105 may be any type of processing unit, such as a processor core, a processor and/or a microcontroller. The processor P105 may execute, among other things, the example processes of FIGS. 2, 3, and 19 to implement the example methods and apparatus described herein.

The processor P105 is in communication with the main memory (including a ROM P120 and/or the RAM P115) via a bus P125. The RAM P115 may be implemented by DRAM, SDRAM, and/or any other type of RAM device, and ROM may be implemented by flash memory and/or any other desired type of memory device. Access to the memory P115 and the memory P120 may be controlled by a memory controller (not shown), One or both of the example memories P115 and P120 may be used to implement databases associated with the central server 102 and/or the local servers 114a and 114b.

The processor platform P100 also includes an interface circuit P130. The interface circuit P130 may be implemented by any type of interface standard, such as an external memory interface, serial port, general-purpose input/output, etc. One or more input devices P135 and one or more output devices P140 are connected to the interface circuit P130.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

### Additional Aspects of the Present Disclosure

To the above ends, and without limiting the following description, in a first aspect of the present disclosure, a venue monitoring and reporting system comprises: a network; a central server in data communication with the network; a customer device in data communication with the network; a local server in data communication with the network, the local server located at a venue remote from the central server; at least one camera in data communication with the local server, the at least one camera positioned and arranged with respect to the venue to view a customer as the customer enters the venue; and wherein the central server, the customer device and the local server cooperate with the network to use images captured by the at least one camera to produce at least one of a total number of customers at the venue or a demographic characteristic of the customers at the venue, wherein the total number or the demographic characteristic at least approximates an actual total number or an actual demographic characteristic of the customers at the venue, and wherein the at least one of the total number of the customers or the demographic characteristic of the customers at the venue is made viewable on the customer device.

In accordance with a second aspect of the present disclosure, which may be used in combination with the first aspect, the customer device is a personal computer, and which includes a website accessible via the network, the at least one of the total number or the demographic characteristic of the customers at the venue selectively viewable via the website on the personal computer.

In accordance with a third aspect of the present disclosure, which may be used in combination with any one or more of the preceding aspects, the customer device is a smartphone, and which includes an application accessible via the network, the network in communication with the smartphone, the at least one of the total number or the demographic characteristic of the customers at the venue selectively viewable via the application on the smartphone.

In accordance with a fourth aspect of the present disclosure, which may be used in combination with any one or more of the preceding aspects, venue monitoring and reporting system is programmed to enable a condition concerning the total number or the demographic characteristic of the customers to be entered, wherein if the condition is met, the customer device is notified.

In accordance with a fifth aspect of the present disclosure, which may be used in combination with any one or more of the preceding aspects, the at least one of the total number or the demographic characteristic of the customers at the venue is updated periodically at the customer device.

In accordance with a sixth aspect of the present disclosure, which may be used in combination with any one or more of the preceding aspects, a location of the customer device may be obtained, and which includes an option to view, on the customer device, at least one of the total number or the demographic characteristic of the customers for any of a plurality of venues located within a geographic range of the location of the customer device.

In accordance with a seventh aspect of the present disclosure, which may be used in combination with any one or more of the preceding aspects, a location of the venue is known, and which includes an option to view, on the customer device, at least one of the total number or the demographic characteristic of the customers for any of a plurality of venues located within a geographic range of the location of the venue.

In accordance with an eighth aspect of the present disclosure, which may be used in combination with any one or more of the preceding aspects, the venue is classified into a type, and which includes an option to view, on the customer device, at least one of the total number or the demographic characteristic of the customers for any of a plurality of venues of the same type.

In accordance with a ninth aspect of the present disclosure, which may be used in combination with any one or more of the preceding aspects, the central server, the customer device and the local server cooperate with the network to use images captured by the at least one camera to additionally produce at least one environmental characteristic associated with the venue, and wherein the environmental characteristic is made viewable on the customer device.

In accordance with a tenth aspect of the present disclosure, which may be used in combination with the ninth aspect, the at least one environmental characteristic includes at least one of a lighting condition, weather condition, local temperature, noise level, music type, line length for entry, crowd pattern, or local traffic pattern.

In accordance with an eleventh aspect of the present disclosure, which may be used in combination with any one or more of the preceding aspects, the central server, the customer device and the local server cooperate with the network to use images captured by the at least one camera to additionally produce still pictures or a video stream of the venue viewable on the customer device.

In accordance with a twelfth aspect of the present disclosure, which may be used in combination with any one or more of the preceding aspects, the demographic characteristic includes age, height, weight, gender, race, facial hair, hair color, hair length, hair style, eye color, jewelry worn, or clothing type.

In accordance with a thirteenth aspect of the present disclosure, which may be used in combination with any one or more of the preceding aspects, the venue monitoring and reporting system is further configured to prepare a packet of data including at least one of the total number or the demographic characteristic of the customers at the venue, the packet optionally including like data from at least one other venue, the packet configured and arranged to be delivered to at least one third party.

In accordance with a fourteenth aspect of the present disclosure, which may be used in combination with any one or more of the preceding aspects, the at least one of a total number or a demographic characteristic of the customers at the venue, and at least one additional piece of information are made available to an operator of the venue.

In accordance with a fifteenth aspect of the present disclosure, which may be used in combination with the fourteenth aspect, the at least one additional piece of information includes a customer analytic, a recommendation concerning an environment of the venue, or a recommendation concerning a product or service provided by the venue.

In accordance with a sixteenth aspect of the present disclosure, which may be used in combination with any one or more of the preceding aspects, the venue monitoring and reporting system is programmed to enable a condition concerning the venue and obtainable by the at least one camera to be entered by a venue operator, wherein information concerning the condition is (i) automatically sent to the venue operator or (ii) selectively accessible by the venue operator.

In accordance with a seventeenth aspect of the present disclosure, which may be used in combination with any one or more of the preceding aspects, the images captured by the at least one camera are analyzed by at least one of the camera, the local server or the central server.

In accordance with an eighteenth aspect of the present disclosure, which may be used in combination with any one or more of the preceding aspects, the at least one camera includes a traffic flow camera and a demographic recognition camera.

In accordance with a nineteenth aspect of the present disclosure, which may be used in combination with any one or more of the preceding aspects, the venue is a first venue, and which includes a second venue including a second at least one camera positioned and arranged with respect to the venue to view a customer as the customer enters the second venue, and wherein the central server and the customer device cooperate with the network to use images captured by the at least one second camera to produce at least one of a total number of customers at the second venue or a demographic characteristic of the customers at the second venue, wherein the total number or the demographic characteristic of the customer at the second venue at least approximates an actual total number or an actual demographic characteristic of the customers at the second venue, and wherein the at least one of the total number or the demographic characteristic of the customers at the second venue is made viewable on the customer device.

In accordance with a twentieth aspect of the present disclosure, which may be used in combination with any one or more of the preceding aspects, the customer device is configured to enable a request for a change of music being played in the venue via the central server.

In accordance with a twenty-first aspect of the present disclosure, which may be used in combination with any one or more of the preceding aspects, the at least one of a total number of customers at the venue for different time periods or a demographic characteristic of the customers at the venue for different time periods are stored at the central server and made available to an operator of the venue.

In accordance with a twenty-second aspect of the present disclosure, which may be used in combination with any one or more of the preceding aspects, a method for venue monitoring and reporting comprises: recording a customer a venue using at least one camera in data communication with a local server, the at least one camera positioned and arranged with respect to the venue to record the customer enters the venue; using images captured by the at least one camera to produce via a central server in data communication with the local server via a network at least one of a total number of customers at the venue or a demographic characteristic of the customers at the venue, wherein the total number or the demographic characteristic at least approximates an actual total number or an actual demographic characteristic of the customers at the venue; and transmitting from the central server to a customer device for display on the customer device the at least one of the total number of the customers or the demographic characteristic of the customers at the venue.

In accordance with a twenty-third aspect of the present disclosure, which may be used in combination with any one or more of the preceding aspects, a venue monitoring and reporting system comprises: a venue; a first camera located with respect to the venue so as to capture a customer entering the venue; a second camera located with respect to the venue so as to identify at least one demographic characteristic of the customer entering the venue; and a computer operating with the first and second cameras, wherein the computer and the first camera update a count of customers entering the venue, and wherein the computer and the second camera update the at least one demographic characteristic of customers entering the venue.

In accordance with a twenty-fourth aspect of the present disclosure, which may be used with any one or more of the preceding aspects in combination with the twenty-third aspect, the computer is located at the venue or is a server computer located remotely from the venue.

In accordance with a twenty-fifth aspect of the present disclosure, which may be used with any one or more of the preceding aspects in combination with the twenty-third aspect, the first camera is located with respect to the venue so as to capture a customer leaving the venue, and wherein the computer and the first camera update a count of customers entering and leaving the venue.

In accordance with a twenty-sixth aspect of the present disclosure, which may be used with any one or more of the preceding aspects in combination with the twenty-third aspect, the venue includes an entranceway, the first camera located closer to the entranceway than the second camera.

In accordance with a twenty-seventh aspect of the present disclosure, which may be used with any one or more of the preceding aspects in combination with the twenty-third aspect, the venue includes an entranceway, and wherein the second camera is at least one of (i) located about one foot (30.5 centimeters) away from the entranceway or (ii) located from about eight feet (2.4 meters) to about fifteen feet (4.6 meters) above the floor.

In accordance with a twenty-eighth aspect of the present disclosure, which may be used with any one or more of the preceding aspects in combination with the twenty-third aspect, the venue includes an entranceway, and wherein the second camera is located from about five feet (1.5 meters) to about fifty feet (15 meters) away from the entrance-way.

In accordance with a twenty-ninth aspect of the present disclosure, which may be used with any one or more of the preceding aspects in combination with the twenty-third aspect, the venue monitoring and reporting system includes a third camera located with respect to the venue so as to identify at least one demographic characteristic of the customer leaving the venue.

In accordance with a thirtieth aspect of the present disclosure, which may be used with any one or more of the preceding aspects in combination with the twenty-ninth aspect, the computer, the second camera and the third camera update the at least one demographic characteristic of customers entering and leaving the venue.

In accordance with a thirty-first aspect of the present disclosure, which may be used with any one or more of the preceding aspects in combination with the twenty-third aspect, the venue monitoring and reporting system includes a customer device enabled to view at least one of (i) a total count of customers at the venue based upon the updated count of customers, or (ii) at least one cumulative demographic characteristic of customers at the venue based upon the updated at least one demographic characteristic of customers entering the venue.

In accordance with a thirty-second aspect of the present disclosure, which may be used with any one or more of the preceding aspects in combination with the thirty-first aspect, the customer device is in operable communication with a sever computer, which is in operable communication with the computer.

In accordance with a thirty-third aspect of the present disclosure, which may be used in combination with any one or more of the preceding aspects, a venue monitoring and reporting system comprises: a venue; a first camera located with respect to the venue so as to capture a customer entering the venue; a first computer operating with the first camera, wherein the first computer and the first camera update a count of customers entering the venue; a second camera located with respect to the venue so as to identify at least one demographic characteristic of the customer entering the venue; and a second computer operating with the second camera, wherein the second computer and the second camera update the at least one demographic characteristic of customers entering the venue.

In accordance with a thirty-fourth aspect of the present disclosure, which may be used with any one or more of the preceding aspects in combination with the thirty-third aspect, at least one of (i) the first computer is housed with the first camera or (ii) the second computer is housed with the second camera.

In accordance with a thirty-fifth aspect of the present disclosure, which may be used with any one or more of the preceding aspects in combination with the thirty-third aspect, the first camera is located with respect to the venue so as to capture a customer leaving the venue, and wherein the first computer and the first camera update a count of customers entering and leaving the venue.

In accordance with a thirty-sixth aspect of the present disclosure, which may be used with any one or more of the preceding aspects in combination with the thirty-third aspect, the venue monitoring and reporting system includes a third computer and a third camera located with respect to the venue so as to identify at least one demographic characteristic of the customer leaving the venue, and wherein the second computer, the third computer, the second camera and the third camera update the at least one demographic characteristic of customers entering and leaving the venue.

In accordance with a thirty-seventh aspect of the present disclosure, which may be used with any one or more of the preceding aspects in combination with the thirty-third aspect, the venue monitoring and reporting system includes a customer device enabled to view at least one of (i) a total count of customers at the venue based upon the updated count of customers, or (ii) at least one cumulative demographic characteristic of customers at the venue based upon the updated at least one demographic characteristic of customers entering the venue.

In accordance with a thirty-eighth aspect of the present disclosure, which may be used in combination with any one or more of the preceding aspects, a venue monitoring and reporting system comprises: a venue; a sensor located with respect to the venue so as to sense a customer in a venue; and a computer operating with the sensor, wherein the computer and the sensor upon sensing the customer (i) update a count of total customers associated with the venue, and (ii) update at least one demographic characteristic of customers associated with the venue.

In accordance with a thirty-ninth aspect of the present disclosure, which may be used with any one or more of the preceding aspects in combination with the thirty-eighth aspect, the sensor includes a camera that captures the customer entering the venue and identifies the at least one demographic characteristic of the customer.

In accordance with a fortieth aspect of the present disclosure, which may be used with any one or more of the preceding aspects in combination with the thirty-eighth aspect, the sensor includes a radio frequency detector to sense the customer by detecting a signal from a mobile device of the customer.

In accordance with a forty-first aspect of the present disclosure, which may be used with any one or more of the preceding aspects in combination with the thirty-eighth aspect, the sensor including a radio frequency (“RF”) detector, the RF detector and the computer identifying at least one demographic characteristic of the customer by (i) detecting a signal from a mobile device of the customer, (ii) determining an identity of the customer based upon the information within the signal, and (iii) referencing the identity of the customer to a database including profile information associated with the customer.

In accordance with a forty-second aspect of the present disclosure, which may be used with any one or more of the preceding aspects in combination with the thirty-eighth aspect, the venue monitoring and reporting system includes a customer device enabled to view at least one of (i) a count of total customers at the venue based upon the updated count of total customers, or (ii) at least one cumulative demographic characteristic of customers at the venue based upon the updated at least one demographic characteristic of customers associated with the venue.

In accordance with a forty-third aspect of the present disclosure, any of the structure and functionality illustrated and described in connection with FIGS. 1 to 22 may be used in combination with any of the structure and functionality illustrated and described in connection with any of the other of FIGS. 1 to 22 and with any one or more of the preceding aspects.

The invention is claimed as follows:

1. A venue monitoring and reporting system comprising:
a network;
a central server in data communication with the network;
a customer device in data communication with the network;
a local server in data communication with the network, the local server located at a venue remote from the central server;
at least one camera in data communication with the local server, the at least one camera positioned and arranged with respect to the venue to view a customer as the customer enters the venue; and
wherein the central server, the customer device and the local server cooperate with the network to use images captured by the at least one camera to produce at least one of a total number of customers at the venue or a demographic characteristic of the customers at the venue, wherein the total number or the demographic characteristic at least approximates an actual total number or an actual demographic characteristic of the customers at the venue, and wherein the at least one of the total number of the customers or the demographic characteristic of the customers at the venue is made viewable on the customer device.

2. The venue monitoring and reporting system of claim 1, wherein the customer device is a personal computer, and which includes a website accessible via the network, the at least one of the total number or the demographic characteristic of the customers at the venue selectively viewable via the website on the personal computer.

3. The venue monitoring and reporting system of claim 1, wherein the customer device is a smartphone, and which includes an application accessible via the network, the network in communication with the smartphone, the at least one of the total number or the demographic characteristic of the customers at the venue selectively viewable via the application on the smartphone.

4. The venue monitoring and reporting system of claim 1, which is programmed to enable a condition concerning the total number or the demographic characteristic of the customers to be entered, wherein if the condition is met, the customer device is notified.

5. The venue monitoring and reporting system of claim 1, wherein the at least one of the total number or the demographic characteristic of the customers at the venue is updated periodically at the customer device.

6. The venue monitoring and reporting system of claim 1, wherein a location of the customer device may be obtained, and which includes an option to view, on the customer device, at least one of the total number or the demographic characteristic of the customers for any of a plurality of venues located within a geographic range of the location of the customer device.

7. The venue monitoring and reporting system of claim 1, wherein a location of the venue is known, and which includes an option to view, on the customer device, at least one of the total number or the demographic characteristic of the customers for any of a plurality of venues located within a geographic range of the location of the venue.

8. The venue monitoring and reporting system of claim 1, wherein the venue is classified into a type, and which includes an option to view, on the customer device, at least one of the total number or the demographic characteristic of the customers for any of a plurality of venues of the same type.

9. The venue monitoring and reporting system of claim 1, wherein the central server, the customer device and the local server cooperate with the network to use images captured by the at least one camera to additionally produce at least one environmental characteristic associated with the venue, and wherein the environmental characteristic is made viewable on the customer device.

10. The venue monitoring and reporting system of claim 9, wherein the at least one environmental characteristic includes at least one of a lighting condition, weather condition, local temperature, noise level, music type, line length for entry, crowd pattern, or local traffic pattern.

11. The venue monitoring and reporting system of claim 1, wherein the central server, the customer device and the local server cooperate with the network to use images captured by the at least one camera to additionally produce still pictures or a video stream of the venue viewable on the customer device.

12. The venue monitoring and reporting system of claim 1, wherein the demographic characteristic includes age, height, weight, gender, race, facial hair, hair color, hair length, hair style, eye color, jewelry worn, or clothing type.

13. The venue monitoring and reporting system of claim 1, which is further configured to prepare a packet of data including at least one of the total number or the demographic characteristic of the customers at the venue, the packet optionally including like data from at least one other venue, the packet configured and arranged to be delivered to at least one third party.

14. The venue monitoring and reporting system of claim 1, wherein the at least one of a total number or a demographic characteristic of the customers at the venue, and at least one additional piece of information are made available to an operator of the venue.

15. The venue monitoring and reporting system of claim 14, wherein the at least one additional piece of information includes a customer analytic, a recommendation concerning an environment of the venue, or a recommendation concerning a product or service provided by the venue.

16. The venue monitoring and reporting system of claim 1, which is programmed to enable a condition concerning the venue and obtainable by the at least one camera to be entered by a venue operator, wherein information concerning the condition is (i) automatically sent to the venue operator or (ii) selectively accessible by the venue operator.

17. The venue monitoring and reporting system of claim 1, wherein the images captured by the at least one camera are analyzed by at least one of the camera, the local server or the central server.

18. The venue monitoring and reporting system of claim 1, wherein the at least one camera includes a traffic flow camera and a demographic recognition camera.

19. The venue monitoring and reporting system of claim 1, wherein the venue is a first venue, and which includes a second venue including a second at least one camera positioned and arranged with respect to the venue to view a customer as the customer enters the second venue, and wherein the central server and the customer device cooperate with the network to use images captured by the at least one second camera to produce at least one of a total number of customers at the second venue or a demographic characteristic of the customers at the second venue, wherein the total number or the demographic characteristic of the customer at the second venue at least approximates an actual total number or an actual demographic characteristic of the customers at the second venue, and wherein the at least one of the total number or the demographic characteristic of the customers at the second venue is made viewable on the customer device.

20. The venue monitoring and reporting system of claim 1, wherein the customer device is configured to enable a request for a change of music being played in the venue via the central server.

21. The venue monitoring and reporting system of claim 1, wherein the at least one of a total number of customers at the venue for different time periods or a demographic characteristic of the customers at the venue for different time periods are stored at the central server and made available to an operator of the venue.

22. A method for venue monitoring and reporting comprising:
recording a customer a venue using at least one camera in data communication with a local server, the at least one camera positioned and arranged with respect to the venue to record the customer enters the venue;
using images captured by the at least one camera to produce via a central server in data communication with the local server via a network at least one of a total number of customers at the venue or a demographic characteristic of the customers at the venue, wherein the total number or the demographic characteristic at least approximates an actual total number or an actual demographic characteristic of the customers at the venue; and
transmitting from the central server to a customer device for display on the customer device the at least one of the total number of the customers or the demographic characteristic of the customers at the venue.
